(19) United States
(12) Patent Application Publication
(10) Pub. No.: US 2005/0195353 A1
(43) Pub. Date: Sep. 8, 2005

(54) Liquid crystal display apparatus and method of manufacturing the same

(76) Inventors: Won-Sang Park, Yongin-si (KR); Kee-Han Uh, Yongin-si (KR); Jae-Hyun Kim, Suwon-si (KR); Sang-Woo Kim, Suwon-si (KR); Jae-Ik Lim, Chuncheon-si (KR); Sung-Eun Cha, Geoje-si (KR); Jae-Young Lee, Seoul (KR)

Correspondence Address: CANTOR COLBURN, LLP, 55 GRIFFIN ROAD SOUTH, BLOOMFIELD, CT, 06002, US

(21) Appl. No.: 11/075,293

(22) Filed: Mar. 8, 2005

(30) Foreign Application Priority Data
Mar. 8, 2004 (KR) 2004-15441
Mar. 17, 2004 (KR) 2004-17958

(51) Int. Cl. G02F 1/1343

(52) U.S. Cl. 349/139

(57) ABSTRACT

A LCD apparatus and a method of manufacturing the same. The LCD apparatus includes a lower plate having a pixel region and a switching element disposed in the pixel region, a pixel electrode formed in the pixel region of the lower plate and electrically coupled to an electrode of the switching element, the pixel electrode having a plurality of pixel electrode portions and at least one connecting portion that electrically connects the pixel electrode portions to each other, an upper plate having a display region corresponding to the pixel region, a common electrode formed on the upper plate and having a plurality of opening patterns that corresponds to the pixel electrode portions, respectively, a liquid crystal layer formed between the pixel electrode and the common electrode. Therefore, a viewing angle is increased to improve an image display quality.

The present application claims priority to Korean Patent Application No. 2004-15441, filed on Mar. 8, 2004 and Korean Patent Application No. 2004-17958, filed on Mar. 17, 2004, the disclosure of which is hereby incorporated herein by reference in their entireties.

### BACKGROUND OF THE INVENTION

1. Field of the Invention

The present invention relates to a liquid crystal display (LCD) apparatus and a method of manufacturing the LCD apparatus. More particularly, the present invention relates to a LCD apparatus capable of improving a viewing angle and an image display quality, and a method of manufacturing the LCD apparatus.

2. Description of the Related Art

LCD apparatuses change the arrangement of liquid crystals disposed between an array substrate and a color filter substrate, in response to an electric field applied thereto, resulting in displaying images. The display quality of LCD apparatuses depends on a viewing angle. LCD apparatuses display images within a viewing angle, and the displayed images have a contrast ratio of more than 10:1. A viewing angle is limited to a particular range. A display apparatus for a desktop monitor, for example, has a viewing angle of greater than 90 degrees. A contrast ratio is the measure of the difference of brightness levels between the brightest white and the darkest black. When LCD apparatuses display a darker image or have a uniform luminance, the contrast ratio increases.

In order to display the darker image, LCD apparatuses decrease the light leakage of LCD panel, adopt a black mode, and decrease the reflectivity of a black matrix. When an electric field is not applied to the liquid crystals of LCD apparatuses, LCD apparatuses display black images in the black mode. In order to obtain uniform luminance, LCD apparatuses include a compensation film and a liquid crystal layer having a multi-domain.

A wide viewing angle, such as a multi-domain vertical alignment (MVA), a patterned vertical alignment (PVA) mode, an in-plane switching (IPS) mode, etc., has been developed in order to improve the viewing angle. In order to adopt the MVA mode, LCD apparatus form protrusions on a color filter substrate and a thin film transistor (TFT) substrate to form a multi-domain in a liquid crystal layer. Because a process for forming the protrusions on the color filter and TFT substrates is required for wide view LCD apparatuses, a manufacturing cost of LCD apparatuses is increased.

When LCD apparatuses adopt the PVA mode, slits are formed in a common electrode of a color filter substrate to form a distorted electric field between the common electrode and a pixel electrode of a TFT substrate. The arrangement of the liquid crystal disposed on the slits, however, may not be controlled so that an aperture ratio of the LCD apparatuses is decreased. In particular, when small sized LCD apparatuses adopt the PVA mode, the aperture ratio of the small sized LCD apparatuses is greatly decreased so that the luminance of the small sized LCD apparatuses is decreased.

When LCD apparatuses adopt the IPS mode, a TFT substrate includes two electrodes arranged in parallel with each other. Thus, an electric field is distorted, resulting in decreasing the luminance of the LCD apparatuses. In addition, when the surfaces of the color filter and TFT substrates are rubbed to align liquid crystals, the surfaces may be irregularly rubbed so that image display quality may be deteriorated.

### SUMMARY OF THE INVENTION

The present invention provides a liquid crystal display (LCD) apparatus capable of improving a viewing angle and an image display quality.

The present invention also provides a method of manufacturing the above-mentioned LCD apparatus.

According to one aspect of the present invention, a liquid crystal display apparatus comprises a lower plate including a pixel region and a switching element disposed in the pixel region; a pixel electrode formed in the pixel region of the lower plate and electrically coupled to an electrode of the switching element, the pixel electrode including a plurality of pixel electrode portions and at least one connecting portion that electrically connects the pixel electrode portions to each other; an upper plate including a display region corresponding to the pixel region; a common electrode disposed on the upper plate, the common electrode including a plurality of opening patterns that correspond to the pixel electrode portions, respectively; and a liquid crystal layer interposed between the pixel electrode and the common electrode.

According to another aspect of the present invention, a liquid crystal display apparatus comprises a lower plate including a pixel region and a switching element disposed in the pixel region, the pixel region including a transmission window and a reflection region; a pixel electrode electrically coupled to an electrode of the switching element, the pixel electrode including: a transparent electrode in the transmission window of the lower plate, the transparent electrode having a transparent conductive material; a reflecting electrode in the reflection region of the lower plate, the reflecting electrode having a conductive material having high reflectivity; and a connecting portion electrically connecting the transparent electrode to the reflecting electrode; an upper plate including a display region corresponding to the pixel region; a common electrode disposed on the upper plate, the common electrode including a plurality of opening patterns that corresponds to the transparent electrode and the reflecting electrode, respectively; and a liquid crystal layer interposed between the pixel electrode and the common electrode.

According to another aspect of the present invention, a liquid crystal display apparatus comprises a lower plate including a pixel region and a switching element disposed in the pixel region; a pixel electrode formed in the pixel region of the lower plate and electrically coupled to an electrode of the switching element; a storage capacitor disposed on the lower plate, a portion of the storage capacitor protruded toward a central line of the pixel region; an upper plate including a display region corresponding to the pixel region; a common electrode disposed on the upper plate, the common electrode corresponding to the pixel electrode; and a liquid crystal layer interposed between the pixel electrode and the common electrode.

According to another aspect of the present invention, a method of manufacturing a liquid crystal display apparatus comprises forming a switching element in a pixel region of a lower plate; forming a pixel electrode including a plurality of pixel electrode portions and at least one connecting portion electrically connecting the pixel electrode portions to each other in the pixel region of the lower plate, the pixel electrode being electrically coupled to an electrode of the switching element; depositing a first transparent conductive material on an upper plate including a display region corresponding to the pixel region; removing a portion of the first transparent conductive material corresponding to central portions of the pixel electrode portions to form a plurality of opening patterns; and forming a liquid crystal layer between the pixel electrode and the first transparent conductive material including the opening patterns.

According to another aspect of the present invention, a method of manufacturing a liquid crystal display apparatus comprises forming a switching element on a lower plate including a pixel region, the pixel region including a transmission window and a reflection region; forming an insulating layer on the lower plate including the switching element, the insulating layer including a contact hole through which an electrode of the switching element is partially exposed; depositing a first transparent conductive material on the insulating layer; partially etching the first transparent conductive material to form a transparent electrode including a plurality of transparent electrode portions, a first connecting portion electrically connecting the transparent electrode portions to each other, and a second connecting portion electrically connecting one of the transparent electrode portions to the electrode of the switching element; depositing a conductive material having high reflectivity on the lower plate including the transparent electrode; partially etching the deposited conductive material to form a reflecting electrode that is electrically coupled to the transparent electrode; depositing a second transparent conductive material on an upper plate including a display region corresponding to the pixel region; removing a portion of the second transparent conductive material corresponding to central portions of the transparent electrode portions to form opening patterns; and forming a liquid crystal layer between the transparent electrode and the second transparent conductive material and between the reflecting electrode and the second transparent conductive material.

According to another aspect of the present invention, a method of manufacturing a liquid crystal display apparatus comprises forming a semiconductor circuit on a lower plate including a pixel region; forming a pixel electrode electrically coupled to a first electrode of a switching element of the semiconductor circuit in the pixel region of the lower plate, the pixel electrode including a plurality of pixel electrode portions and at least one connecting portion electrically connecting the pixel electrode portions to each other; depositing a transparent conductive material on an upper plate including a display region corresponding to the pixel region; removing a portion of the deposited transparent conductive material corresponding to central portions of the pixel electrode portions to form a plurality of opening patterns, each of the opening patterns including a plurality of first recesses; and forming a liquid crystal layer between the pixel electrode and the deposited transparent conductive material.

According to another aspect of the present invention, the LCD apparatus includes a transmissive type LCD apparatus, a reflective type LCD apparatus, a transmissive-reflective LCD apparatus, etc. The common electrode, for example, includes opening patterns corresponding to the pixel electrode portions to form the domains adjacent to the opening patterns. Each of the pixel electrode portions, for example, includes the square shape having rounded corners to increase the number of the domains. Each of the opening patterns, for example, includes a circular shape. Therefore, the domains are radially formed adjacent to each of the opening patterns, and a viewing angle of the LCD apparatus is increased. Each of the opening patterns, for example, includes the first recesses to form the domains corresponding to the first recesses.

### BRIEF DESCRIPTION OF THE DRAWINGS

The above and other advantages of the present invention will become more apparent by describing in detail exemplary embodiments thereof with reference to the accompanying drawings, in which:

FIG. 1 is a plan view showing a liquid crystal display (LCD) apparatus in accordance with an exemplary embodiment of the present invention;

FIG. 2 is a plan view showing a transparent electrode and a reflecting electrode shown in FIG. 1;

FIG. 3 is a plan view showing a common electrode shown in FIG. 1;

FIG. 4 is a cross-sectional view taken along a line I-I′ of FIG. 1;

FIGS. 5A to 5G are cross-sectional views showing a method of manufacturing a LCD apparatus in accordance with an exemplary embodiment of the present invention;

FIG. 6 is a cross-sectional view showing a LCD apparatus in accordance with another exemplary embodiment of the present invention;

FIG. 7 is a plan view showing a LCD apparatus in accordance with another exemplary embodiment of the present invention;

FIG. 8 is a cross-sectional view taken along a line II-II′ of FIG. 7;

FIG. 9 is a plan view showing a LCD apparatus in accordance with another exemplary embodiment of the present invention;

FIG. 10 is a cross-sectional view taken along a line III-III′ of FIG. 9;

FIG. 11 is a plan view showing a LCD apparatus in accordance with another exemplary embodiment of the present invention;

FIG. 12 is a cross-sectional view taken along a line IV-IV′ of FIG. 11;

FIG. 13 is a plan view showing a LCD apparatus in accordance with another exemplary embodiment of the present invention;

FIG. 14 is a cross-sectional view taken along a line V-V′ of FIG. 13;

FIG. 15 is a cross-sectional view taken along a line VI-VI′ of FIG. 13;

FIG. 16 is a plan view showing a gate electrode, a gate line, a first storage electrode, and a storage capacitor line shown in FIG. 13;

FIG. 17 is a plan view showing a source electrode, a source line, a drain electrode, and a second storage electrode shown in FIG. 13;

FIG. 18 is a plan view showing a thin film transistor (TFT), a gate line, a source line, a storage capacitor, and a storage capacitor line shown in FIG. 13;

FIGS. 19A to 19F are cross-sectional views showing a method of manufacturing a LCD apparatus in accordance with another exemplary embodiment of the present invention;

FIG. 20 is a plan view showing a LCD apparatus in accordance with another exemplary embodiment of the present invention;

FIG. 21 is a cross-sectional view taken along a line VII-VII′ of FIG. 20; and

FIG. 22 is a plan view showing a multi-domain formed in a liquid crystal layer shown in FIG. 20; and

FIG. 23 is a cross-sectional view showing a LCD apparatus in accordance with another exemplary embodiment of the present invention.

### DESCRIPTION OF THE INVENTION

It should be understood that the exemplary embodiments of the present invention described below may be variably modified in many different ways without departing from the inventive principles disclosed herein, and the scope of the present invention is therefore not limited to these particular following embodiments. Rather, these embodiments are provided so that this disclosure will be thorough and complete, and will fully convey the concept of the invention to those skilled in the art by way of example and not of limitation.

Hereinafter, the present invention will be described in detail with reference to the accompanying drawings.

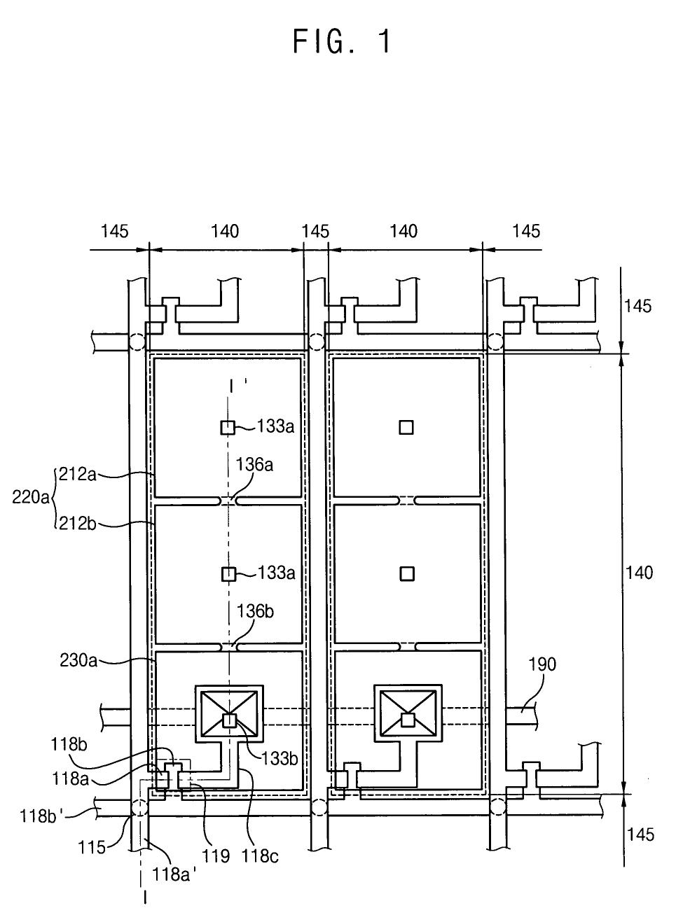

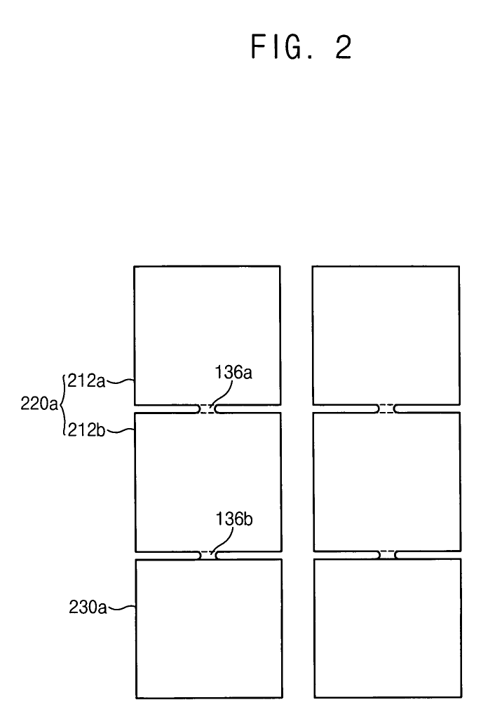

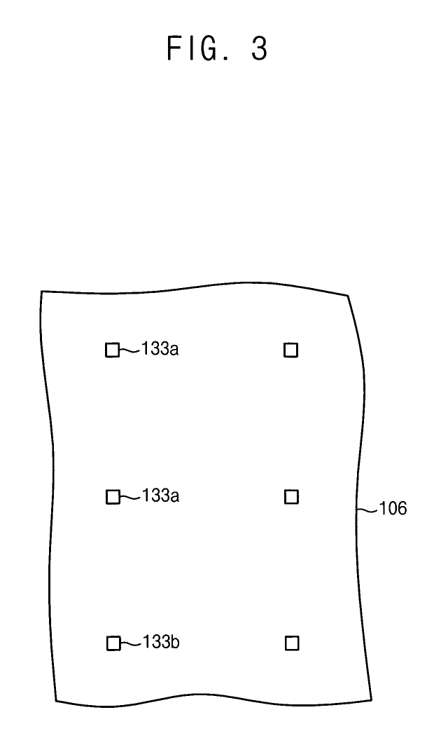

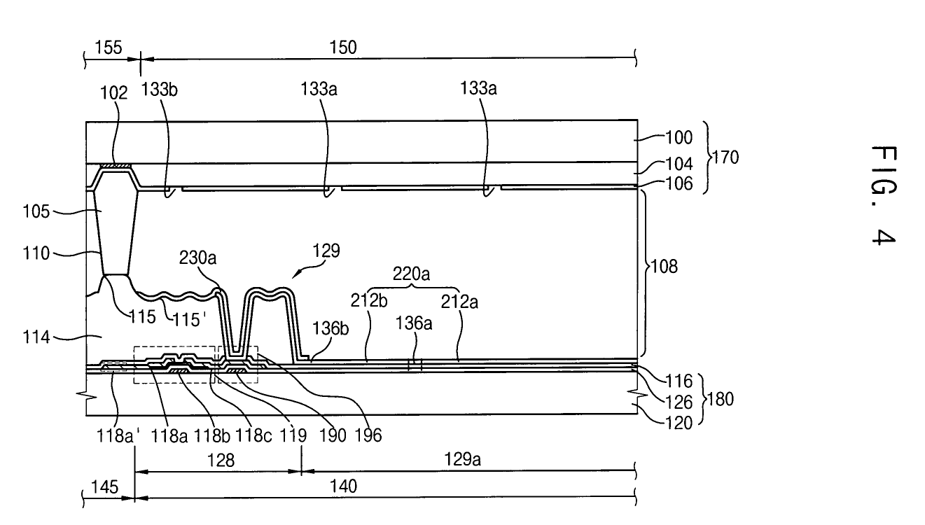

FIG. 1 is a plan view showing a liquid crystal display (LCD) apparatus in accordance with an exemplary embodiment of the present invention. FIG. 2 is a plan view showing a transparent electrode and a reflecting electrode shown in FIG. 1. FIG. 3 is a plan view showing a common electrode shown in FIG. 1. FIG. 4 is a cross-sectional view taken along a line I-I′ of FIG. 1.

Referring to FIGS. 1 to 4, the LCD apparatus includes a first substrate 170, a second substrate 180, and a liquid crystal layer 108. The first substrate 170 includes an upper plate 100, a black matrix 102, a color filter 104, a common electrode 106, and a spacer 110. The first substrate 170 has a display region 150 and a peripheral region 155. An image is displayed in the display region 150. The peripheral region 155 surrounds the display region 150.

The second substrate 180 includes a lower plate 120, a switching element, such as, a thin film transistor (TFT) 119, a source line 118a′, a gate line 118b′, a storage capacitor line 190, a gate insulating layer 126, a passivation layer 116, a storage capacitor 196, an organic layer 114, a transparent electrode 220a, and a reflecting electrode 230a.

The second substrate 180 includes a pixel region 140 and a light blocking region 145. The image is displayed in the pixel region 140. A light may not pass through the light blocking region 145. The pixel region 140 and the light blocking region 145 correspond to the display region 150 and the peripheral region 155, respectively. The pixel region 140 has a transmission window 129a and a reflection region 128. A light generated from a backlight assembly (not shown) passes through the transmission window 129a. A light that is provided from the second substrate 180 is reflected from the reflection region 128. The transmission window 129a, for example, has a quadrangular shape that is extended in a direction substantially parallel with the source line 118a′.

The liquid crystal layer 108 is interposed between the first and second substrates 170 and 180.

The upper and lower plates 100 and 120 include a transparent glass, respectively. The light passes through the transparent glass. The upper and lower plates 100 and 120 may not include alkaline ions. When the alkaline ions are dissolved in the liquid crystal layer 108, the resistivity of the liquid crystal layer 108 is decreased, thereby decreasing the image display quality and the adhesion between a sealant (not shown) and the plates 100 and 120. In addition, the characteristics of the TFT 119 may be deteriorated.

Alternatively, the upper and lower substrates 100 and 120 may include triacetylcellulose (TAC), polycarbonate (PC), polyethersulfone (PES), polyethyleneterephthalate (PET), polyethylenenaphthalate (PEN), polyvinylalcohol (PVA), polymethylmethacrylate (PMMA), cyclo-olefin polymer (COP), etc. The upper and lower substrates 100 and 120 may be either optically isotropic or optically anisotropic.

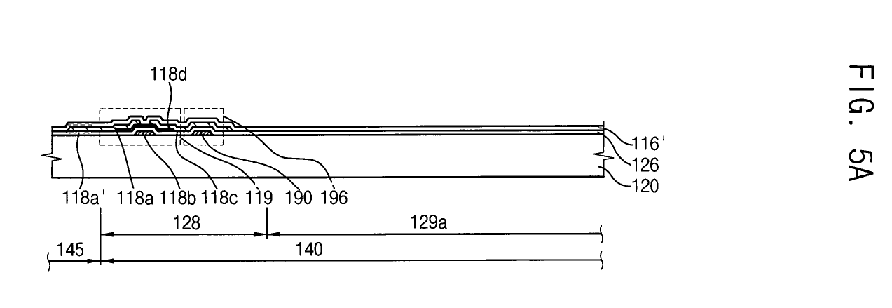

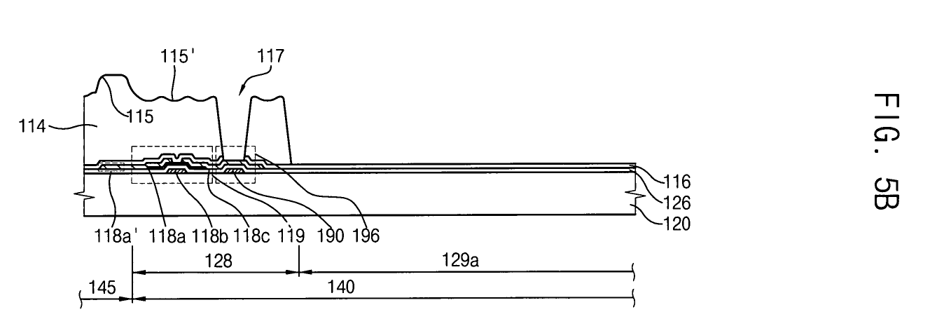

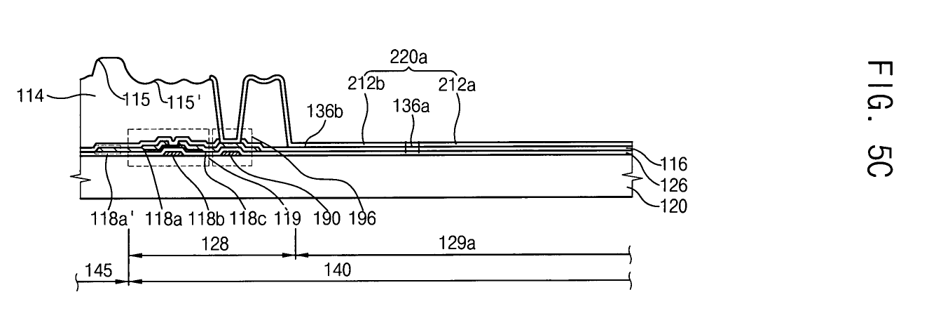

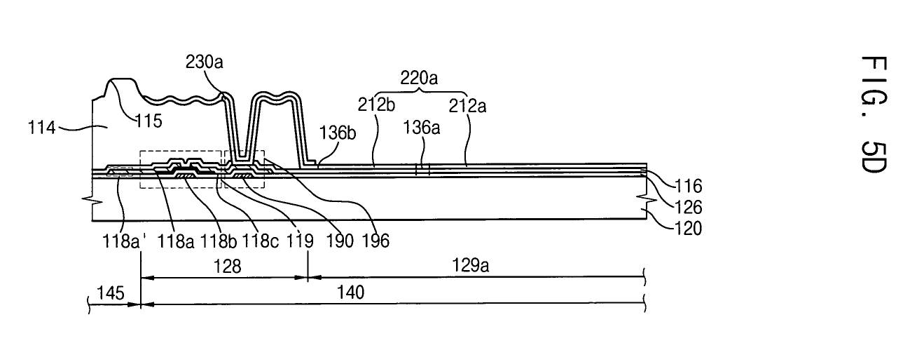

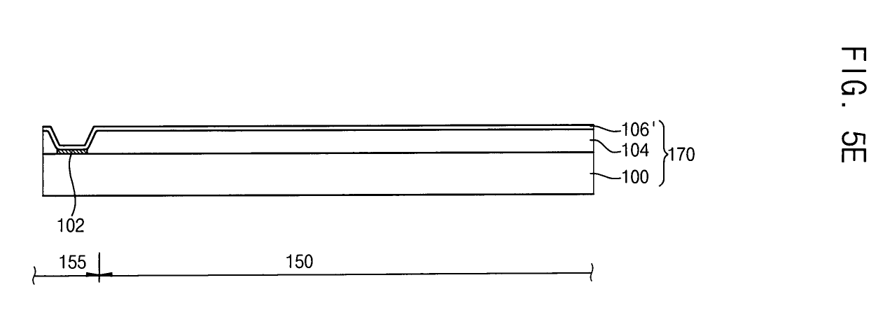

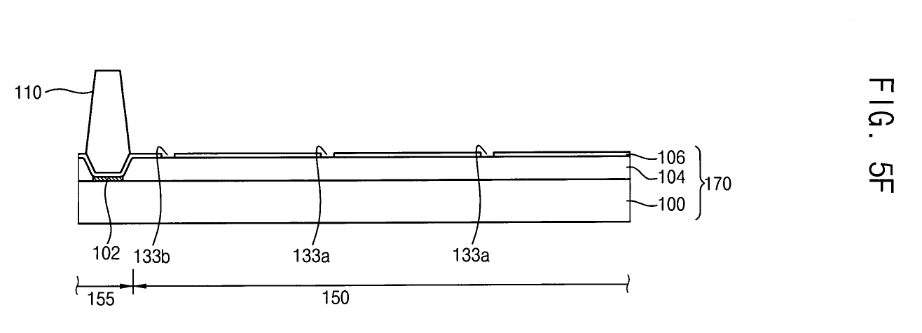

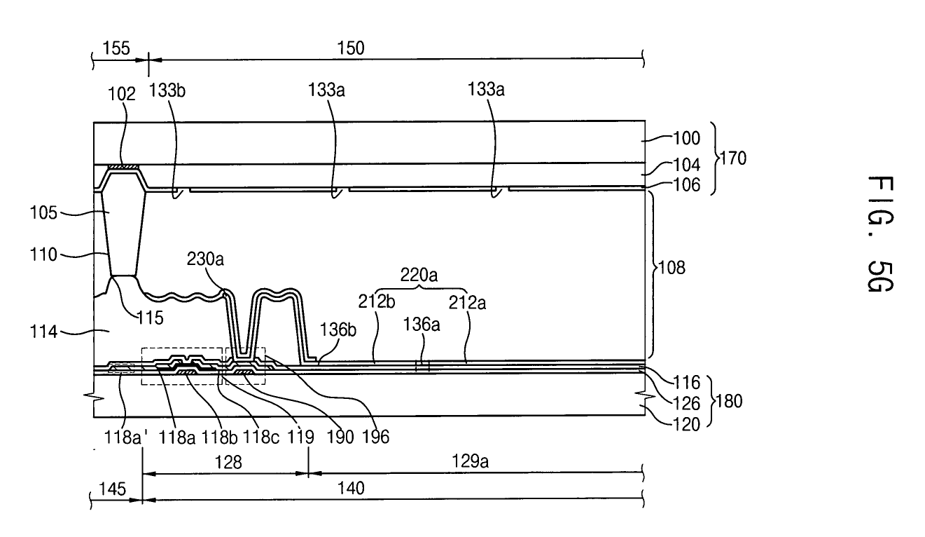

The TFT 119 is disposed on a portion of the lower plate 120 corresponding to the reflection region 128 and includes a source electrode 118a, a gate electrode 118b, a drain electrode 118c, and a semiconductor layer 118d (shown in FIG. 5A). A driving integrated circuit (not shown) applies the source electrode 118a with a data voltage through the source line 118a′, and applies the gate electrode 118b with a gate signal through the gate line 118b′.

The gate insulating layer 126 is formed over the lower plate 120 having the gate electrode 118b. Therefore, the gate electrode 118b is electrically insulated from the source electrode 118a and the drain electrode 118c. The gate insulating layer 126 may include silicon oxide (SiOx), silicon nitride (SiNx), etc.

The passivation layer 116 is disposed over the lower plate 120 having the TFT 119 and the gate insulating layer 126. The passivation layer 116 includes a contact hole 117 (shown in FIG. 5B). The drain electrode 118c is partially exposed through the contact hole 117. The passivation layer 116 may include the silicon oxide (SiOx), the silicon nitride (SiNx), etc.

The storage capacitor 196 has the storage capacitor line 190. The storage capacitor 196 is formed on the lower plate 120 to maintain a voltage difference between the reflecting electrode 230a and the common electrode 106 and a voltage difference between the transparent electrode 220a and the common electrode 106. Alternatively, the gate line 118b′ is partially overlapped with the transparent electrode 220a to form the storage capacitor 196.

The organic layer 114 is disposed on the lower plate 120 having the TFT 119 and the passivation layer 126. Thus, the TFT 119 is electrically insulated from the transparent electrode 220a and the reflecting electrode 230a. The organic layer 114 includes the contact hole 117 through which the drain electrode 118c is partially exposed.

A portion of the organic layer 114 corresponding to the transmission window 129a is removed. Therefore, the transmission window 129a is opened, and the transmission window 129a of the second substrate 180 has different thickness from that of the reflection region 128 of the second substrate 180. In this case, a stepped portion 129 is formed between the transmission window 129a and the reflection region 128. Alternatively, the portion of the organic layer 114 may remain in the transmission window 129a.

The organic layer 114 has a protruded portion 115 and an embossed portion 115′. The protruded portion 115 is disposed on a portion of the organic layer 114 corresponding to the spacer 110 of the first substrate 170 to arrange an alignment of the liquid crystal layer 108. The protruded portion 115, for example, makes contact with the spacer 110. The embossed portion 115′ increases the luminance of a light that is reflected from the reflecting electrode 230a when viewed in front of the LCD apparatus. The reflecting electrode 230a is formed along the embossed portion 115′ in the reflection region 128.

The transparent electrode 220a is formed on a portion of the organic layer 114 corresponding to the pixel region 140, in the contact hole 117, and on the passivation layer 116 in the transmission window 129a. Therefore, the transparent electrode 220a is electrically coupled to the drain electrode 118c. When the voltages are applied to the common electrode 106 and the transparent electrode 220a, the liquid crystal of the liquid crystal layer 108 is controlled to change the light transmittance of the liquid crystal layer 108. The transparent electrode 220a includes indium tin oxide (ITO), indium zinc oxide (IZO), zinc oxide (ZO), etc.

The transparent electrode 220a includes a first transparent electrode portion 212a, a second transparent electrode portion 212b, a first connecting portion 136a and a second connecting portion 136b. The first and second transparent electrode portions 212a and 212b are formed on the passivation layer 116 in the transmission window 129a. The first transparent electrode portion 212a is adjacent to the second transparent electrode portion 212b.

The first connecting portion 136a is formed between the first and second transparent electrode portions 212a and 212b to electrically connect the first transparent electrode portion 212a to the second transparent electrode portion 212b. Each of the first and second transparent portions 212a and 212b may have a polygonal shape, a circular shape, etc. Each of the first and second transparent electrode portions 212a and 212b may have a quadrangular shape. Each of the first and second transparent electrode portions 212a and 212b, for example, has a square shape.

The second connecting portion 136b is opposite to the first connecting portion 136a with respect to the second transparent electrode portion 212b to electrically connect the second transparent electrode portion 212b to the reflecting electrode 230a. The second transparent electrode portion 136b may be extended into the contact hole 117 to make electrical contact with the drain electrode 118c of the TFT 119.

The reflecting electrode 230a is disposed on a portion of the organic layer 114 corresponding to the reflection region 128. The reflecting electrode 230a, for example, is disposed along the embossed portion 115′ of the organic layer 114. Therefore, the externally provided light is reflected from the reflecting electrode 230a into a predetermined direction. The reflecting electrode 230a includes a conductive material, and is electrically coupled to the drain electrode 118c through the transparent electrode 220a. The reflecting electrode 230a may have a polygonal shape, a circular shape, etc. The reflecting electrode 230a may have a quadrangular shape. The reflecting electrode 230a, for example, has a square shape.

Alternatively, a second protecting layer (not shown) may be formed on the reflecting electrode 230a and the transparent electrode 220a. The second protecting layer (not shown) is not rubbed to have a smooth surface and a uniform thickness. Alternatively, the second protecting layer (not shown) may be rubbed in a predetermined rubbing direction. The second protecting layer (not shown) has a synthetic resin such as a polyimide (PI) resin.

The black matrix 102 is disposed in the peripheral region 155 of the upper plate 100 to block the internally and externally provided lights. The black matrix 102 blocks the light passing through the light blocking region 145 to improve the image display quality.

A metallic material or an opaque organic material is deposited on the upper plate 100 and is etched to form the black matrix 102. The metallic material of the black matrix 102 includes chrome (Cr), chrome oxide (CrOx), chrome nitride (CrNx), etc. The opaque organic material includes carbon black, a pigment compound, a colorant compound, etc. The pigment compound may include a red pigment, a green pigment, and a blue pigment, and the colorant compound may include a red colorant, a green colorant, and a blue colorant. Alternatively, the opaque organic material comprising photoresist may be coated on the upper plate 100 to form the black matrix 102 through a photo process against the coated opaque organic material. The edges of a plurality of the color filters may be also overlapped with one another to form the black matrix 102.

The color filter 104 is formed on the display region 150 of the upper plate 100 having the black matrix 102. The internally and externally provided lights having a predetermined wavelength may pass through the color filter 104. The color filter 104 includes a red color filter portion, a green color filter portion, and a blue color filter portion. The color filter 104 includes a photo initiator, a monomer, a binder, a pigment, a dispersant, a solvent, a photoresist, etc. Alternatively, the color filter 104 may be disposed on the lower plate 120 or the passivation layer 116.

The common electrode 106 is formed on the upper plate 100 having the black matrix 102 and the color filter 104. The common electrode 106 includes a transparent conductive material, including for example, indium tin oxide (ITO), indium zinc oxide (IZO), zinc oxide (ZO), etc.

The common electrode 106 includes two first opening patterns 133a and one second opening pattern 133b in unit pixel region 140. These patterns form a multi-domain in the liquid crystal layer 108. The common electrode 106, for example, is partially etched to form the first and second opening patterns 133a and 133b. The first opening patterns 133a is formed over the central portions of the first and second transparent electrode portions 212a and 212b, respectively. The second opening pattern 133b is formed over a central portion of the reflecting electrode 230a.

The spacer 110 is formed on the upper plate 100 having the black matrix 102, the color filter 104, and the common electrode 106. The first substrate 170 is disposed apart from the second substrate 180 using the spacer 110 therebetween. The spacer 110, for example, is disposed at a position corresponding to the black matrix 102, and has a column shape. Alternatively, the spacer 110 may include a ball shaped spacer or a mixture of the column shaped spacer and the ball shaped spacer.

Alternatively, a first protecting layer (not shown) may be formed on the common electrode 106, the first opening patterns 133a, and the second opening pattern 133b. The first protecting layer (not shown) is not rubbed to have a smooth surface and a uniform thickness. Alternatively, the first protecting layer (not shown) may be rubbed in a predetermined rubbing direction. The first protecting layer (not shown) has a synthetic resin such as a polyimide (PI) resin.

The liquid crystal layer 108 is interposed between the first and second substrates 170 and 180, and sealed by a sealant (not shown). The liquid crystal layer 108 may include a vertical alignment (VA) mode, a twisted nematic (TN) mode, a mixed twisted nematic (MTN) mode or a homogeneous alignment mode. The liquid crystal layer 108, for example, includes the vertical alignment (VA) mode.

The arrangement of the liquid crystals in the liquid crystal layer 108 may be distorted by rubbing the first and second substrates 170 and 180. Therefore, the stepped portion 129, the protruded portion 115, and the spacer 110 are used to incline the liquid crystal in the liquid crystal layer 108 in a predetermined direction, instead of performing a rubbing the first and second substrates 170 and 180.

When a LCD apparatus, for example, includes the transparent electrode 220a and the reflecting electrode 230a of extended shape, the liquid crystals in the liquid crystal layer 108 may be inclined to a central line of the electrodes 220a and 230a, resulting in poor arrangements of the liquid crystals around the central line. In order to prevent the poor arrangements of the liquid crystals at the central line of the transparent and reflection electrodes 220a and 230a, the LCD apparatus includes the first and second transparent electrode portions 212a and 212b each having a square shape, the reflecting electrode 230 having the square shape, and the opening patterns 133a and 133b. The liquid crystal in the liquid crystal layer 108 is inclined toward the central portion of each of the first and second transparent electrode portions 212a and 212b and the reflecting electrode 230. Therefore, the inclination of the liquid crystal in the liquid crystal layer 108 is concentrated on the central portion of each of the first and second transparent electrode portions 212a and 212b and the reflecting electrode 230.

When voltages are applied to the transparent electrode 220a, the reflecting electrode 230a, and the common electrode 106, a distorted electric field is formed in a region adjacent to the protruded portion 115 of the second substrate 180 and the spacer 110 of the first substrate 170, the stepped portion 129 between the transmission window 129a and the reflection region 128, a region adjacent to each of the opening patterns 133a and 133b, a region between the first and second transparent electrode portions 212a and 212b, and a region between the second transparent electrode portion 212b and the reflecting electrode 230a. When the distorted electric field is applied to the liquid crystal layer 108, the multi-domain is formed in the liquid crystal layer 108. Therefore, the viewing angle of the LCD apparatus is improved, and an image display quality of the LCD apparatus is improved. In addition, four domains are formed adjacent to each of the opening patterns 133a and 133b. Therefore, a viewing angle of the LCD apparatus is increased.

FIGS. 5A to 5G are cross-sectional views showing a method of manufacturing a LCD apparatus in accordance with an exemplary embodiment of the present invention. Referring to FIG. 5A, the lower plate 120 includes the pixel region 140 and the light blocking region 145. The pixel region 140 includes the transmission window 129a and the reflection region 128. The internally provided light, which is generated from the backlight assembly (not shown), passes through the transmission window 129a, and the externally provided light is reflected from the reflection region 128.

A conductive material is deposited on the lower plate 120. The conductive material, for example, includes a metal. The deposited conductive material is partially removed to form the gate electrode 118b, the gate line 118b′ and the storage capacitor line 190. The gate insulating layer 126 is deposited on the lower plate 120 having the gate electrode 118b, the gate line 118b′ and the storage capacitor line 190. The gate insulating layer 126 includes a transparent insulating material.

Amorphous silicon and N+ type amorphous silicon are deposited on the gate insulating layer 126 and etched to form the semiconductor layer 118d on a portion of the gate insulating layer 126 corresponding to the gate electrode 118b. The N+ type amorphous silicon may be formed through implanting impurities onto the deposited amorphous silicon. A conductive material is deposited on the gate insulating layer 126 having the semiconductor layer 118d. The conductive material deposited on the gate insulating layer 126 is partially etched to form the source electrode 118a, the source line 118a′, the drain electrode 118c, and the storage capacitor 196. Therefore, the TFT 119 including the source electrode 118a, the gate electrode 118b, the drain electrode 118c and the semiconductor layer 118d, and the storage capacitor 196 are formed on the lower plate 120.

A transparent insulating material 116′ is deposited over the lower plate 120 having the TFT 119. The transparent insulating material, for example, includes the silicon oxide (SiOx), the silicon nitride (SiNx), etc.

Referring to FIG. 5B, an organic material is coated over the deposited transparent insulating material 116′ shown in FIG. 5A. The organic material, for example, includes photoresist.

The coated organic material is exposed and developed to form the contact hole 117, the protruded portion 115 and the embossed portion 115′ by using a photo process. Because the organic material disposed on a portion of the transparent insulating material 116′ (FIG. 5A) corresponding to the transmission window 129a is removed, the deposited transparent insulating material 116′ in the transmission window 129a is exposed. The photo process may be performed using one mask or a plurality of the masks against the coated organic material. When a single mask is used to form the contact hole 117, the transmission window 129a, the embossed portion 115′, and the protruded portion 115, the mask includes an opaque portion, a translucent portion, and the transparent portion. The opaque portion, for example, corresponds to the protruded portion 115. The translucent portion corresponds to the convex and concave, that is, the embossed portion 115′. The transparent portion corresponds to the transmission window 129a. Alternatively, the mask may include a slit. The deposited transparent insulating material 116′ (shown in FIG. 5A) corresponding to the contact hole 117 is partially removed to form the passivation layer 116, and the drain electrode 118c is exposed through the contact hole 117.

Referring to FIG. 5C, a transparent conductive material is deposited on the organic layer 114, in the contact hole 117, and on a portion of the passivation layer 116 corresponding to the transmission window 129a. The transparent conductive material includes indium tin oxide (ITO), indium zinc oxide (IZO), zinc oxide (ZO), etc. The transparent conductive material, for example, includes indium tin oxide (ITO) in an exemplary embodiment as shown. The deposited transparent conductive material is partially etched to form the first transparent electrode portion 212a, the second transparent electrode portion 212b, the first connecting portion 136a, and the second connecting portion 136b. As a result, the transparent electrode 220a is formed on a portion of the passive layer 116 corresponding to the transmission window 129a.

Referring to FIG. 5D, a conductive material having high reflectivity is deposited on the lower plate 120 having the transparent electrode 220a. The conductive material having the high reflectivity, for example, includes aluminum (Al), aluminum alloy, neodymium (Nd), neodymium alloy, etc. The deposited conductivity material having the high reflectivity is partially etched to form the reflecting electrode 230a in the reflection region 128.

Alternatively, the reflecting electrode 230a may have a multi-layered structure. When the reflecting electrode 230a has the multi-layered structure, the reflecting electrode 230a, for example, includes a molybdenum-tungsten (Mo—W) alloy layer and an aluminum-neodymium (Al—Nd) alloy layer disposed on the molybdenum-tungsten (Mo—W) alloy layer. The reflecting electrode 230a is electrically coupled to the drain electrode 118c through the transparent electrode 220a and the contact hole 117 (shown in FIG. 5B).

Alternatively, the reflecting electrode 230a may be formed on the organic layer 114 and in the contact hole 117, and the transparent electrode 220a may be formed in the transmission window 129a and on a portion of the reflection electrode 230a. In this case, the transparent electrode 220a is electrically coupled to the drain electrode 118c through the reflection electrode 230a.

In another exemplary embodiment, the polyimide (PI) resin may be coated on the lower plate 120 having the transparent electrode 220a and the reflecting electrode 230a to form a second protecting layer (not shown). Therefore, the second substrate 180 having the lower plate 120, the TFT 119, the source line 118a′, the gate line 118b′, the organic layer 114, the transparent electrode 220a, and the reflecting electrode 230a is completed.

Referring to FIG. 5E, an opaque material is deposited on the upper plate 100. The deposited opaque material is partially removed to form the black matrix 102. Alternatively, an opaque organic material having photoresist may be coated on the upper plate 100, and the coated opaque organic material is partially removed through the photo process against the coated opaque organic material to form the black matrix 102. The photo process includes the exposure and developing steps. The black matrix 102 may also be formed on the lower plate 120.

The color filter 104 is formed on the upper plate 100 having the black matrix. For example, a red organic material having a red colorant and photoresist is coated on the upper plate 100 having the black matrix 102. The coated red organic material is exposed through a mask, and developed to form the red color filter portion. The green color filter portion and the blue color filter portion are formed on the upper plate 100 having the black matrix 102 and the red color filter portion. A transparent conductive material 106′ is deposited on the upper plate 100 having the color filter 104 and the black matrix 102.

Referring to FIG. 5F, a photoresist film is coated on the deposited transparent conductive material 106′ (shown in FIG. 5E). After the coated photoresist film is exposed through a mask, the coated photoresist film is developed to form a photoresist pattern. The deposited transparent conductive material is etched using the photoresist pattern as an etching mask to form the common electrode 106 having the first and second opening patterns 133a and 133b.

An organic material is coated on the common electrode 106. The organic material, for example, includes the photoresist. The coated organic material is exposed through a mask, and developed to form the spacer 110. The spacer 110 is disposed on a portion of the common electrode 106 corresponding to the black matrix 102. The spacer 110 may also be disposed on the lower plate 120 of the second substrate 180. The polyimide (PI) resin may be coated on the upper plate 100 having the spacer 110 and the common electrode 106 to form the first protecting layer (not shown). Therefore, the first substrate 170 including the upper plate 100, the black matrix 102, the color filter 104, the common electrode 106 having the opening patterns 133a and 133b, and the spacer 110 is completed.

Referring to FIG. 5G, the first substrate 170 is combined with the second substrate 180. The liquid crystal is injected into a space between the first and second substrates 170 and 180. The injected liquid crystal is sealed by the sealant (not shown) that is formed between the first and second substrates 170 and 180 to form the liquid crystal layer 108. Alternatively, the liquid crystal may be dropped on the first substrate 170 or the second substrate 180 having the sealant (not shown). Therefore, the first substrate 170 is combined with the second substrate 180 to form the liquid crystal layer 108. A multi-domain is formed adjacent to the opening patterns 133a and 133b, thus increasing the viewing angle of the LCD apparatus.

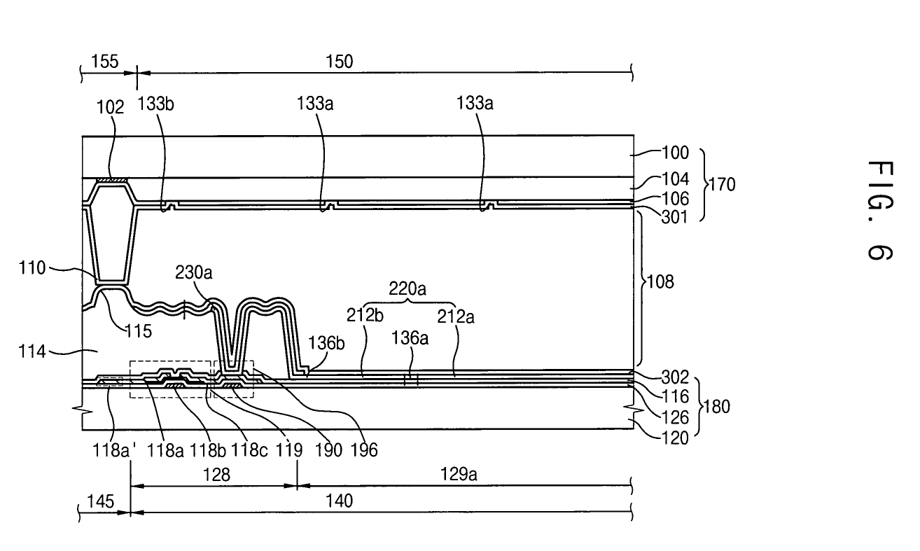

FIG. 6 is a cross-sectional view showing a LCD apparatus in accordance with another exemplary embodiment of the present invention. The LCD apparatus of FIG. 6 is the same as in FIGS. 1 to 4 except for a first protecting layer and a second protecting layer. Thus, the same reference numerals will be used to refer to the same or like parts as those described in FIGS. 1 to 4 and any further explanation will be omitted.

Referring to FIG. 6, the LCD apparatus includes a first substrate 170, a second substrate 180, and a liquid crystal layer 108. The first substrate 170 includes an upper plate 100, a black matrix 102, a color filter 104, a common electrode 106, a spacer 110, and a first protecting layer 301. The first substrate 170 has a display region 150 and a peripheral region 155. An image is displayed in the display region 150 that is surrounded by the peripheral region 155.

The second substrate 180 includes a lower plate 120, a thin film transistor (TFT) 119, a source line 118a′, a gate line 118b′, a storage capacitor line 190, a gate insulating layer 126, a passivation layer 116, a storage capacitor 196, an organic layer 114, a transparent electrode 220a, a reflecting electrode 230a and a second protecting layer 302.

The second substrate 180 includes a pixel region 140 and a light blocking region 145. The image is displayed in the pixel region 140. A light may not pass through the light blocking region 145. The pixel region 140 and the light blocking region 145 correspond to the display region 150 and the peripheral region 155, respectively. The pixel region 140 has a transmission window 129a and a reflection region 128.

The transparent electrode 220a includes a first transparent electrode portion 212a, a second transparent electrode portion 212b, a first connecting portion 136a, and a second connecting portion 136b. The first and second transparent electrode portions 212a and 212b are formed on the passivation layer 116 in the transmission window 129a. The first transparent electrode portion 212a is adjacent to the second transparent electrode portion 212b.

The reflecting electrode 230a is disposed on a portion of the organic layer 114 corresponding to the reflection region 128. Therefore, a light that is provided external to the second substrate 180 is reflected from the reflecting electrode 230a. The second protecting layer 302 may be formed on the reflecting electrode 230a and the transparent electrode 220a. The second protecting layer 302 is not rubbed and has a smooth surface and a uniform thickness. Therefore, a misalignment formed by rubbing is prevented.

The common electrode 106 includes two first opening patterns 133a and one second opening pattern 133b in unit pixel region 140 to form a multi-domain in the liquid crystal layer 108. The first protecting layer 301 may be formed on the common electrode 106 to protect the common electrode 106. The first protecting layer 301 is not rubbed and has a smooth surface and a uniform thickness. Therefore, a misalignment formed by rubbing is prevented. The liquid crystal layer 108 makes contact with the first and second protecting layers 301 and 302.

When voltages are applied to the transparent electrode 220a, the reflecting electrode 230a, and the common electrode 106, a distorted electric field is formed in a region adjacent to each of the opening patterns 133a and 133b, a region between the first and second transparent electrode portions 212a and 212b, and a region between the second transparent electrode portion 212b and the reflecting electrode 230a. When the distorted electric field is applied to the liquid crystal layer 108, the multi-domain is formed in the liquid crystal layer 108. Therefore, the viewing angle of the LCD apparatus is improved.

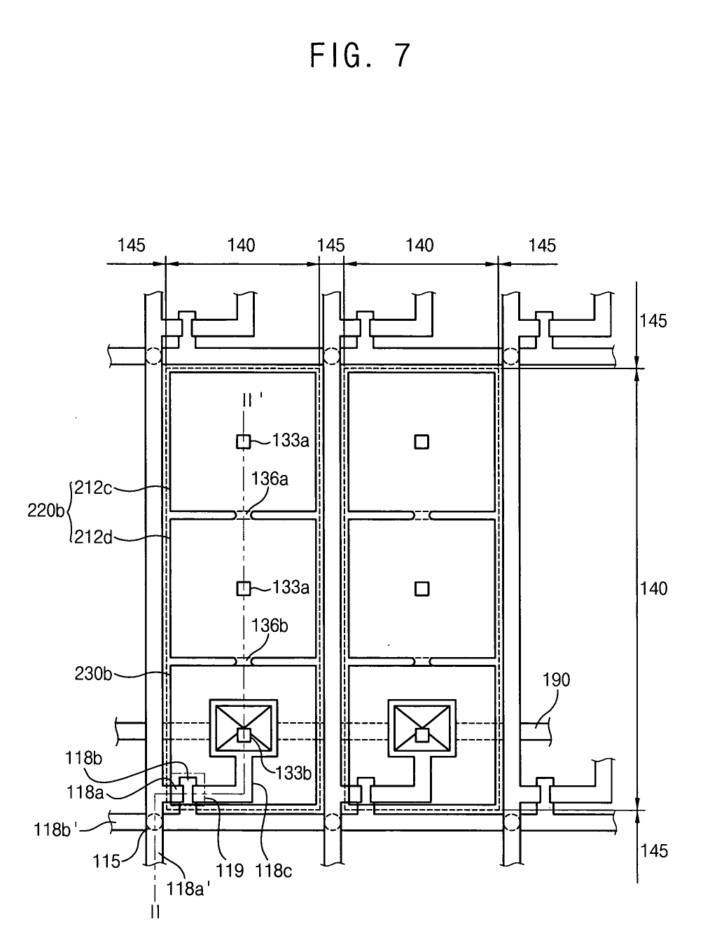

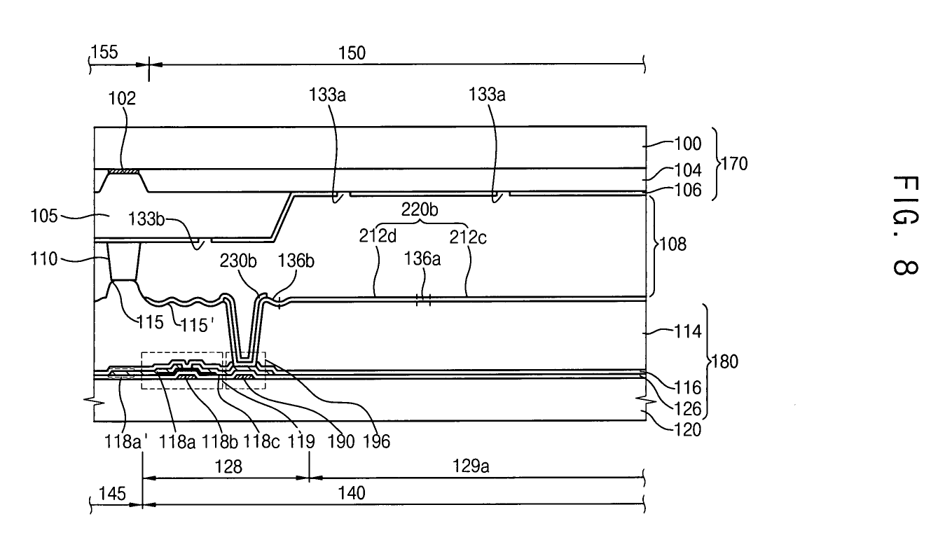

FIG. 7 is a plan view showing a LCD apparatus in accordance with another exemplary embodiment of the present invention. FIG. 8 is a cross-sectional view taken along a line II-II′ of FIG. 7. The LCD apparatus of FIGS. 7 and 8 is the same as in FIGS. 1 to 4 except for an organic layer and an overcoating layer. Thus, the same reference numerals will be used to refer to the same or like parts as those described in FIGS. 1 to 4 and any further explanation will be omitted.

Referring to FIGS. 7 and 8, the LCD apparatus includes a first substrate 170, a second substrate 180, and a liquid crystal layer 108. The first substrate 170 includes an upper plate 100, a black matrix 102, a color filter 104, an overcoating layer 105, a common electrode 106, and a spacer 110. The first substrate 170 has a display region 150 and a peripheral region 155. An image is displayed in the display region 150. The peripheral region 155 surrounds the display region 150.

The second substrate 180 includes a lower plate 120, a thin film transistor (TFT) 119, a source line 118a′, a gate line 118b′, a storage capacitor line 190, a gate insulating layer 126, a passivation layer 116, a storage capacitor 196, an organic layer 114, a transparent electrode 220b, and a reflecting electrode 230b.

The second substrate 180 includes a pixel region 140 and a light blocking region 145. The image is displayed in the pixel region 140. A light may not pass through the light blocking region 145. The pixel region 140 and the light blocking region 145 correspond to the display region 150 and the peripheral region 155, respectively. The pixel region 140 has a transmission window 129a and a reflection region 128. The transmission window 129a has a rectangular shape that is extended in a direction substantially parallel with the source line 118a′.

The organic layer 114 is disposed on the lower plate 120 having the TFT 119 and the passivation layer 126. Therefore, the TFT 119 is electrically insulated from the transparent electrode 220b and the reflecting electrode 230b.

The organic layer 114 includes a protruded portion 115, an embossed portion 115′, and a contact hole (not shown) through which a drain electrode 118c of the TFT 119 is partially exposed. The protruded portion 115 corresponds to the spacer 110 to arrange an alignment of the liquid crystals in the liquid crystal layer 108. The protruded portion 115 makes contact with the spacer 110. The embossed portion 115′ increases the luminance of a light that is reflected from the reflecting electrode 230b when viewed in front of the LCD apparatus. The reflecting electrode 230b is formed along the embossed portion 115′ in the reflection region 128.

The transparent electrode 220b is formed on a portion of the organic layer 114 corresponding to the pixel region 140 and in the contact hole. Therefore, the transparent electrode 220b makes electrical contact with the drain electrode 118c.

The transparent electrode 220b includes a first transparent electrode portion 212c, a second transparent electrode portion 212d, a first connecting portion 136a, and a second connecting portion 136b. The first and second transparent electrode portions 212c and 212d are formed on the organic layer 114 in the transmission window 129a. The first transparent electrode portion 212c is adjacent to the second transparent electrode portion 212d.

Each of the first and second transparent portions 212c and 212d may have a polygonal shape, a circular shape, etc. Each of the first and second transparent electrode portions 212c and 212d may have a quadrangular shape such as a rectangular shape. Each of the first and second transparent electrode portions 212c and 212d, for example, has a square shape including rounded corners.

The reflecting electrode 230b is disposed on a portion of the organic layer 114 corresponding to the reflection region 128. Therefore, a light that is provided external to the second substrate 180 is reflected from the reflecting electrode 230b. When voltages are applied to the transparent electrode 220b, the reflecting electrode 230b, and the common electrode 106, a distorted electric field is formed in a region adjacent to each of the opening patterns 133a and 133b, a region between the first and second transparent electrode portions 212c and 212d, and a region between the second transparent electrode portion 212c and the reflecting electrode 230b. When the distorted electric field is applied to the liquid crystal layer 108, a multi-domain is formed in the liquid crystal layer 108. Therefore, the viewing angle of the LCD apparatus is improved.

The overcoating layer 105 is formed on the upper plate 100 having the black matrix 102 and the color filter 104 to protect the black matrix 102 and the color filter 104. A portion of the overcoating layer 105 corresponding to the transmission window 129a is removed from the upper plate 100. Thus, a portion of the color filter 104 corresponding to the transmission window 129a is exposed. Therefore, a portion of the first substrate 170 corresponding to the transmission window 129a has a different thickness from that of a portion of the first substrate 170 corresponding to the reflection region 128. Alternatively, the overcoating layer 105 corresponding to the transmission window 129a may remain on the upper plate 100. The overcoating layer 105 also planarizes a surface of the first substrate 170 having the black matrix 102 and the color filter 104.

The common electrode 106 includes two first opening patterns 133a and one second opening pattern 133b in unit pixel region 140 to form a multi-domain in the liquid crystal layer 108. The common electrode 106 is partially etched to form the first and second opening patterns 133a and 133b.

Because the thickness of the overcoating layer 105 is controlled, a portion of the first substrate 170 corresponding to the transmission window 129a has different thickness from that of a portion of the first substrate 170 corresponding to the reflection region 128. Therefore, the optical characteristics of the liquid crystal layer 108 is controlled.

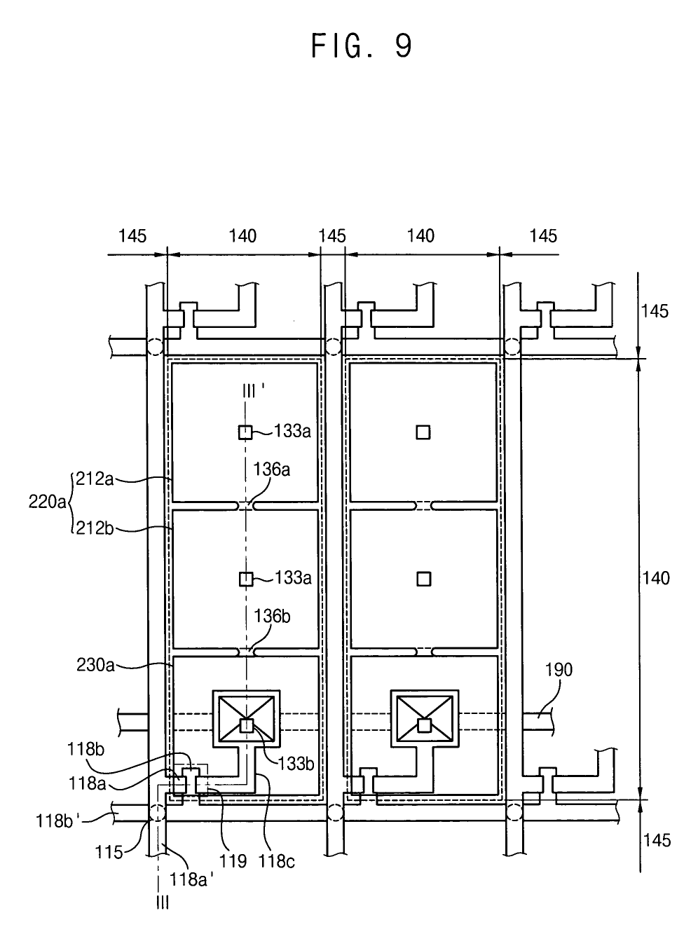

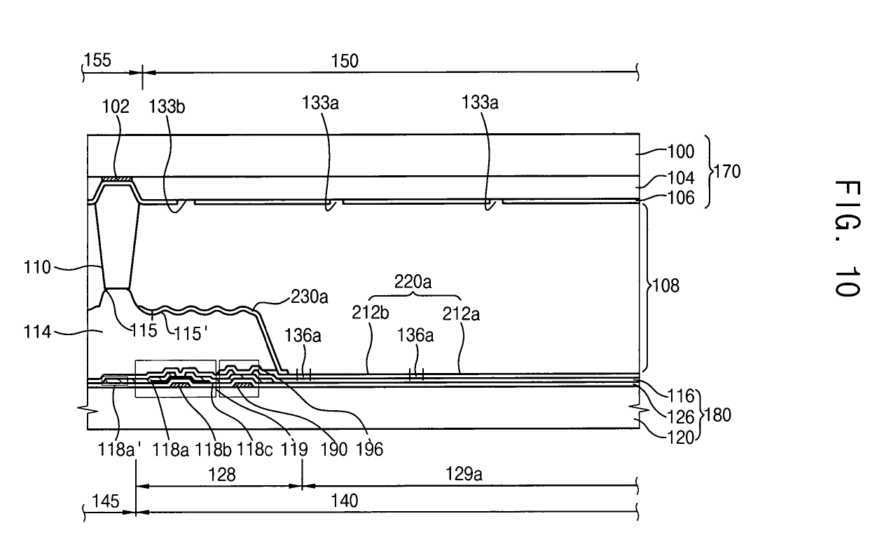

FIG. 9 is a plan view showing a LCD apparatus in accordance with another exemplary embodiment of the present invention. FIG. 10 is a cross-sectional view taken along a line III-III′ of FIG. 9. The LCD apparatus of FIGS. 9 and 10 is the same as in FIGS. 1 to 4 except for a transparent electrode. Thus, the same reference numerals will be used to refer to the same or like parts as those described in FIGS. 1 to 4 and any further explanation will be omitted.

Referring to FIGS. 9 and 10, the LCD apparatus includes a first substrate 170, a second substrate 180, and a liquid crystal layer 108. The first substrate 170 includes an upper plate 100, a black matrix 102, a color filter 104, a common electrode 106, and a spacer 110. The first substrate 170 has a display region 150 and a peripheral region 155. An image is displayed in the display region 150 that is surrounded by the peripheral region 155.

The second substrate 180 includes a lower plate 120, a thin film transistor (TFT) 119, a source line 118a′, a gate line 118b′, a storage capacitor line 190, a gate insulating layer 126, a passivation layer 116, a storage capacitor 196, an organic layer 114, a transparent electrode 220a, and a reflecting electrode 230a.

The second substrate 180 includes a pixel region 140 and a light blocking region 145. The image is displayed in the pixel region 140. A light may not pass through the light blocking region 145. The pixel region 140 and the light blocking region 145 correspond to the display region 150 and the peripheral region 155, respectively. The pixel region 140 has a transmission window 129a and a reflection region 128. The transmission window 129a, for example, has a rectangular shape that is extended in a direction substantially parallel with the source line 118a′.

The passivation layer 116 is disposed over the lower plate 120 having the TFT 119. The passivation layer 116 includes a contact hole through which the drain electrode 118c is partially exposed.

The transparent electrode 220a is formed in the pixel region 140 of the passivation layer 116 and in the contact hole. Therefore, the transparent electrode 220a is electrically coupled to a drain electrode 118c of the TFT 119. The transparent electrode 220a includes a first transparent electrode portion 212a, a second transparent electrode portion 212b, a first connecting portion 136a, and a second connecting portion 136b.

The organic layer 114 is disposed on the lower plate 120 having the TFT 119, the passivation layer 116, and the transparent electrode 220a. The reflection electrode 230a is disposed on a portion of the organic layer 114 corresponding to the reflection region 120. Therefore, the TFT 119 is insulated from the reflection electrode 230a.

A portion of the organic layer 114 corresponding to the transmission window 129a is removed. Therefore, the transmission window 129a of the second substrate 180 has different thickness from that of the reflection region 128 of the second substrate 180. Alternatively, the portion of the organic layer 114 may remain in the transmission window 129a. When the portion of the organic layer 114 partially remains in the transmission window 129a, the organic layer 114 has a contact hole through which the transparent electrode 220a makes electrical contact with the reflecting electrode 230a.

The organic layer 114 has a protruded portion 115 and an embossed portion 115′. The protruded portion 115 corresponds to the spacer 110 to arrange an alignment of the liquid crystal layer 108. The protruded portion 115, for example, makes contact with the spacer 110. The embossed portion 115′ increases the luminance of a light that is reflected from the reflecting electrode 230a when viewed in front of the LCD apparatus. The reflecting electrode 230a is formed along the embossed portion 115′ in the reflection region 128.

A portion of the reflecting electrode 230a is formed on the second connecting portion 136b of the transparent electrode 220a. Therefore, the reflecting electrode 230a is electrically coupled to the drain electrode 118c through the transparent electrode 220a. Because the second connecting portion 136b is disposed under the organic layer 114, the organic layer 114 may not have a contact hole. Therefore, a structure of the organic layer 114 is simplified, and a manufacturing cost of the LCD apparatus is decreased.

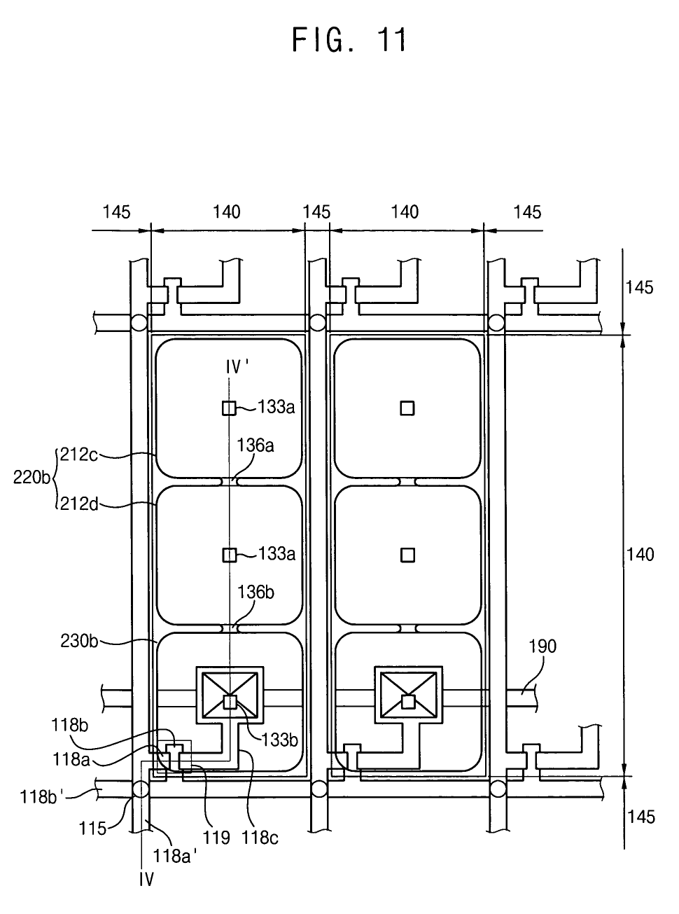

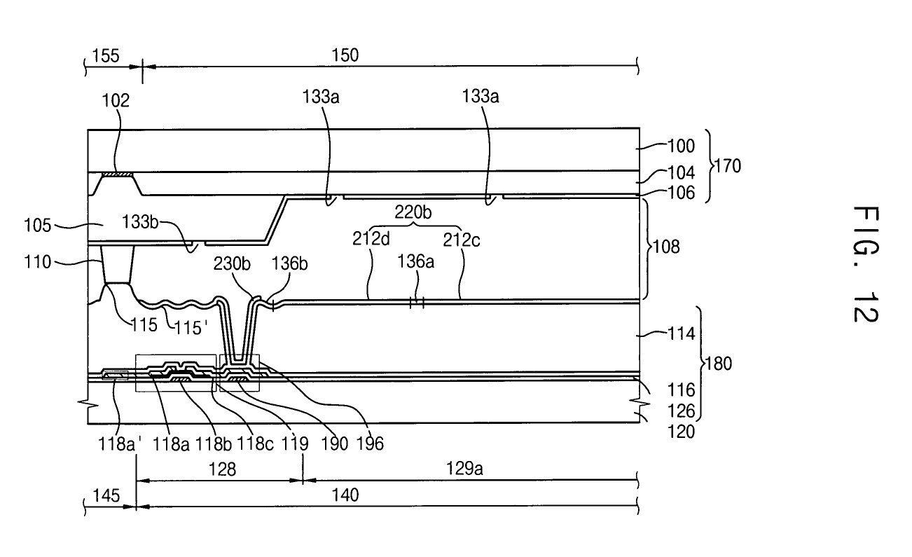

FIG. 11 is a plan view showing a LCD apparatus in accordance with another exemplary embodiment of the present invention. FIG. 12 is a cross-sectional view taken along a line IV-IV′ of FIG. 11. The LCD apparatus of FIGS. 11 and 12 is the same as in FIGS. 1 to 4 except for a transparent electrode, a reflecting electrode, an organic layer, and an overcoating layer. Thus, the same reference numerals will be used to refer to the same or like parts as those described in FIGS. 1 to 4 and any further explanation will be omitted.

Referring to FIGS. 11 and 12, the LCD apparatus includes a first substrate 170, a second substrate 180, and a liquid crystal layer 108. The first substrate 170 includes an upper plate 100, a black matrix 102, a color filter 104, an overcoating layer 105, a common electrode 106, and a spacer 110. The first substrate 170 has a display region 150 and a peripheral region 155. An image is displayed in the display region 150 that is surrounded by the peripheral region 155.

The second substrate 180 includes a lower plate 120, a thin film transistor (TFT) 119, a source line 118a′, a gate line 118b′, a storage capacitor line 190, a gate insulating layer 126, a passivation layer 116, a storage capacitor 196, an organic layer 114, a transparent electrode 220b, and a reflecting electrode 230b.

The second substrate 180 includes a pixel region 140 and a light blocking region 145. The image is displayed in the pixel region 140. A light may not pass through the light blocking region 145. The pixel region 140 and the light blocking region 145 correspond to the display region 150 and the peripheral region 155, respectively. The pixel region 140 has a transmission window 129a and a reflection region 128. The transmission window 129a, for example, has a rectangular shape that is extended in a direction substantially parallel with the source line 118a′.

The organic layer 114 is disposed on the lower plate 120 having the TFT 119 and the passivation layer 126. Therefore, the TFT 119 is electrically insulated from the transparent electrode 220b and the reflecting electrode 230b.

The organic layer 114 has a protruded portion 115, an embossed portion 115′ and a contact hole (not shown) through which a drain electrode 118c of the TFT 119 is exposed. The protruded portion 115 corresponds to the spacer 110 to arrange an alignment of the liquid crystal layer 108. The protruded portion 115, for example, makes contact with the spacer 110. The embossed portion 115′ increases the luminance of a light that is reflected from the reflecting electrode 230b when viewed in front of the LCD apparatus. The reflecting electrode 230b is formed along the embossed portion 115′ in the reflection region 128.

The transparent electrode 220b is formed on a portion of the organic layer 114 corresponding to the pixel region 140 and in the contact hole. Therefore, the transparent electrode 220b is electrically coupled to the drain electrode 118c.

The transparent electrode 220b includes a first transparent electrode portion 212c, a second transparent electrode portion 212d, a first connecting portion 136a, and a second connecting portion 136b. Each of the first and second transparent electrode portions 212c and 212d has a polygonal shape, a circular shape, etc. Each of the first and second transparent electrode portions 212c and 212d, for example, has a square shape having rounded corners.

The reflecting electrode 230b is disposed on a portion of the organic layer 114 corresponding to the reflection region 128. Therefore, an externally provided light is reflected from the reflecting electrode 230b. The reflecting electrode 230b may have a polygonal shape, a circular shape, etc. The reflecting electrode 230b, for example, has a square shape including rounded corners.

When voltages are applied to the transparent electrode 220b, the reflecting electrode 230b, and the common electrode 106, a distorted electric field is formed in a region adjacent to each of the opening patterns 133a and 133b, a region between the first and second transparent electrode portions 212c and 212d, and a region between the second transparent electrode portion 212d and the reflecting electrode 230b. When the distorted electric field is applied to the liquid crystal layer 108, a multi-domain is formed in the liquid crystal layer 108. Therefore, the viewing angle of the LCD apparatus is improved.

The overcoating layer 105 is formed on the upper plate 100 having the black matrix 102 and the color filter 104 to protect the black matrix 102 and the color filter 104. The overcoating layer 105 planarizes the first substrate 170 having the black matrix 102 and the color filter 104. Alternatively, a portion of the overcoating layer 105 may remain on a portion of the color filter 104 corresponding to the transmission window 129a.

The common electrode 106 includes two first opening patterns 133a and one second opening pattern 133b in unit pixel region 140 to form a multi-domain in the liquid crystal layer 108. The common electrode 106, for example, is partially etched to form the first and second opening patterns 133a and 133b.

Because each of the first and second transparent electrode portions 212c and 212d and the reflecting electrode 230b has the square shape including the rounded corners, the number of domains formed adjacent to each of the opening patterns 133a and 133b is increased. Therefore, a viewing angle of the LCD apparatus is increased.

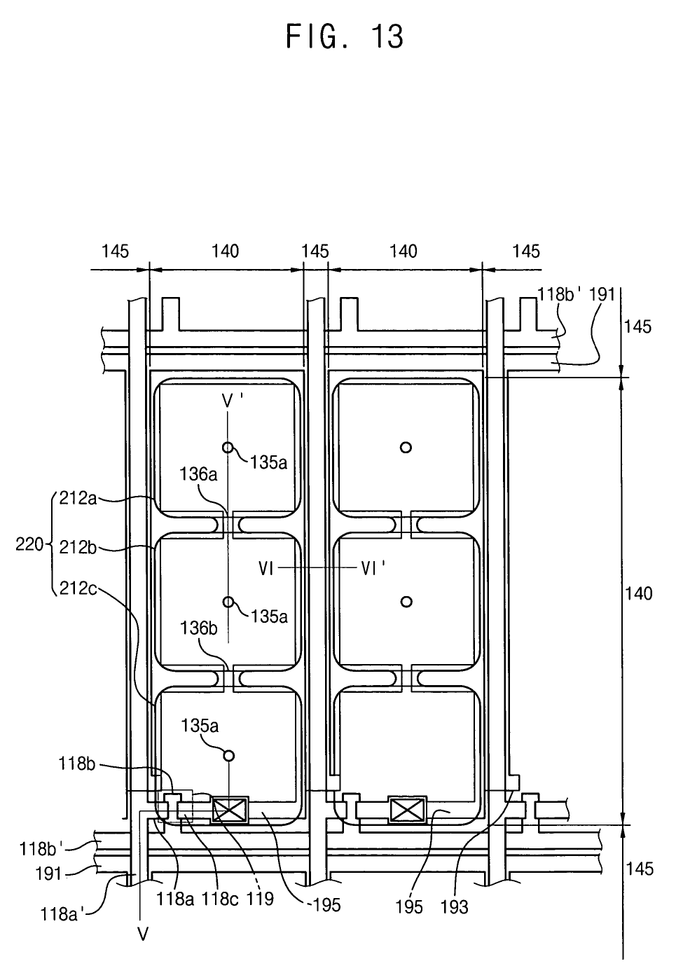

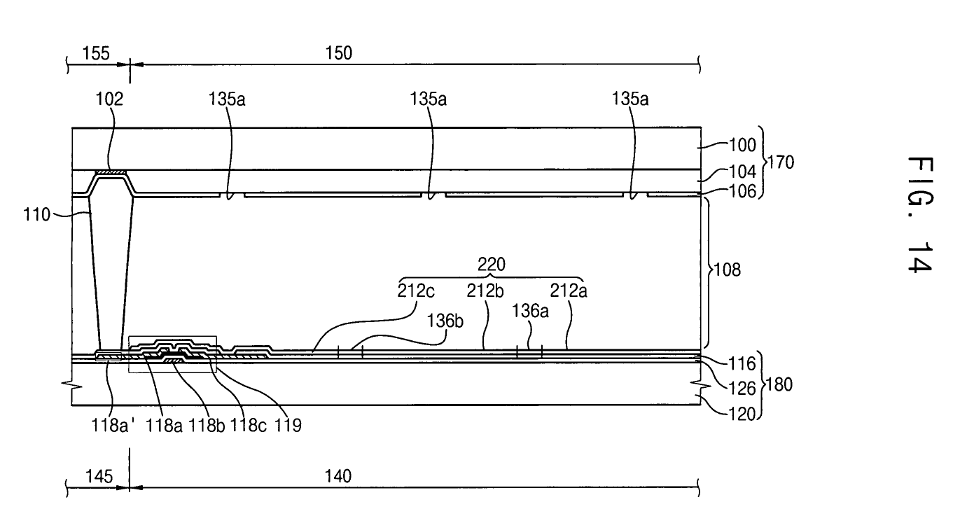

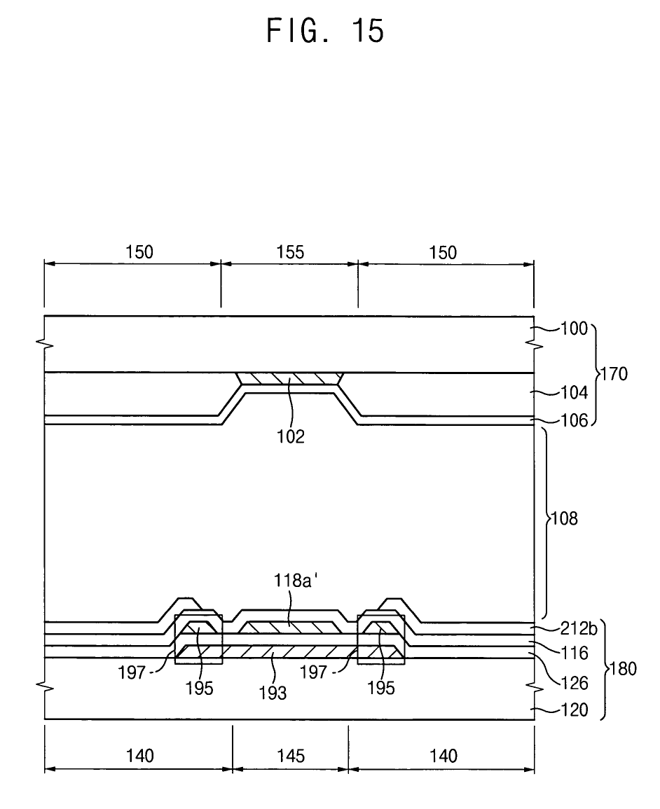

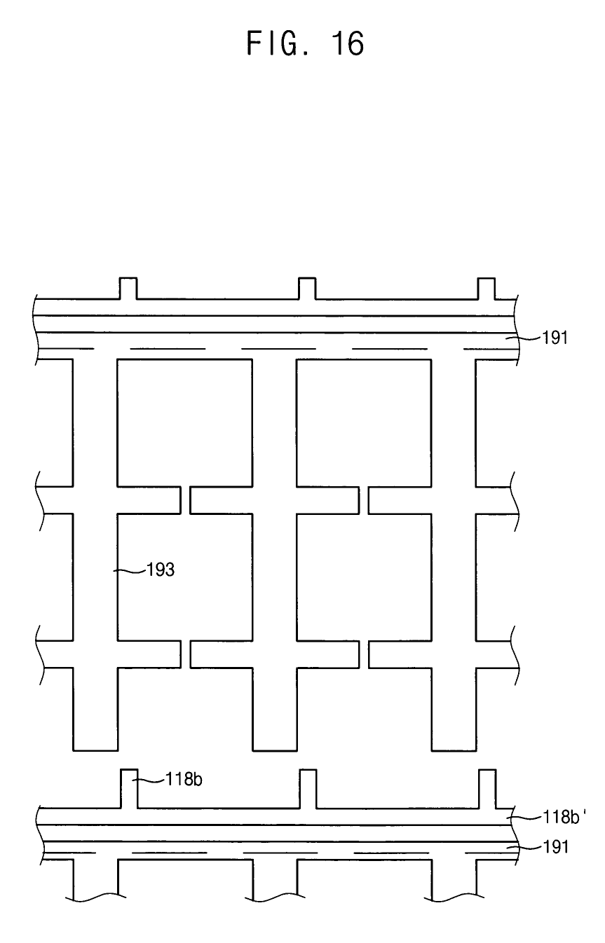

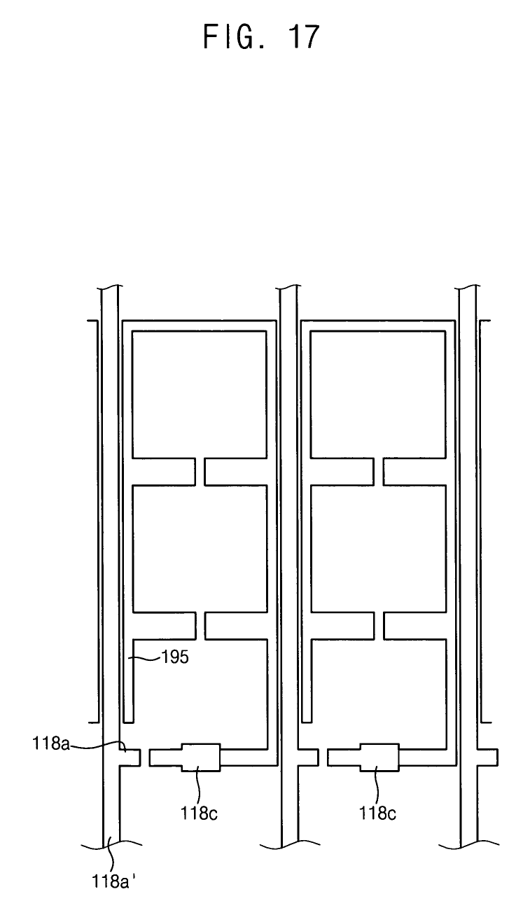

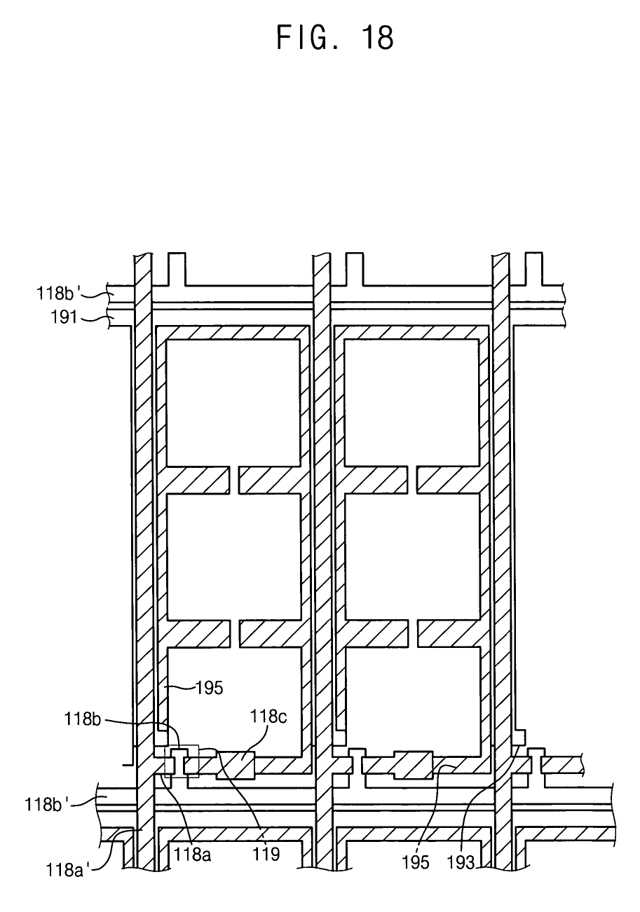

FIG. 13 is a plan view showing a LCD apparatus in accordance with another exemplary embodiment of the present invention. FIG. 14 is a cross-sectional view taken along a line V-V′ of FIG. 13. FIG. 15 is a cross-sectional view taken along a line VI-VI′ of FIG. 13. FIG. 16 is a plan view showing a gate electrode, a gate line, a first storage electrode, and a storage capacitor line shown in FIG. 13. FIG. 17 is a plan view showing a source electrode, a source line, a drain electrode, and a second storage electrode shown in FIG. 13. FIG. 18 is a plan view showing a thin film transistor (TFT), a gate line, a source line, a storage capacitor, and a storage capacitor line shown in FIG. 13. The LCD apparatus of FIGS. 13 to 18 is the same as in FIGS. 1 to 4 except for a pixel electrode, an organic layer, and a storage capacitor. Thus, the same reference numerals will be used to refer to the same or like parts as those described in FIGS. 1 to 4 and any further explanation will be omitted.

Referring to FIGS. 13 to 18, the LCD apparatus includes a first substrate 170, a second substrate 180, and a liquid crystal layer 108. The first substrate 170 includes an upper plate 100, a black matrix 102, a color filter 104, a common electrode 106, and a spacer 110. The first substrate 170 has a display region 150 and a peripheral region 155. An image is displayed in the display region 150 that is surrounded by the peripheral region 155.

The second substrate 180 includes a lower plate 120, a thin film transistor (TFT) 119, a source line 118a′, a gate line 118b′, a storage capacitor line 191, a gate insulating layer 126, a passivation layer 116, a storage capacitor 197, and a pixel electrode 220.

The second substrate 180 includes a pixel region 140 and a light blocking region 145. The image is displayed in the pixel region 140. A light may not pass through the light blocking region 145. The pixel region 140 and the light blocking region 145 correspond to the display region 150 and the peripheral region 155, respectively. The pixel region 140, for example, has a rectangular shape that is extended in a direction substantially parallel with the source line 118a′.

The passivation layer 116 is disposed over the lower plate 120 having the TFT 119. The passivation layer 116 includes a contact hole (not shown) through which the drain electrode 118c is partially exposed. Alternatively, an organic layer (not shown) may be formed on the lower plate 120 having the TFT 119 and the passivation layer 116.

The pixel electrode 220 is formed on a portion of the passivation layer 116 corresponding to the pixel region 140 and in the contact hole. Therefore, the pixel electrode 220 is electrically coupled to the drain electrode 118c. When voltages are applied to the pixel electrode 220 and the common electrode 106, an electric field is formed between the pixel electrode 220 and the common electrode 106. Liquid crystals in the liquid crystal layer 108 vary their arrangement in response to the electric field, and a light transmittance of the liquid crystal layer 108 is changed to display an image. The pixel electrode 220 has a transparent conductive material such as indium tin oxide (ITO), indium zinc oxide (IZO), zinc oxide (ZO), etc. Alternatively, the pixel electrode 220 may have a conductive material having high reflectivity.

The pixel electrode 220 includes a first pixel electrode portion 212a, a second pixel electrode portion 212b, a third pixel electrode portion 212c, a first connecting portion 136a, and a second connecting portion 136b. The first connecting portion 136a is between the first and second pixel electrode portions 212a and 212b to electrically connect the first pixel electrode portion 212a to the second pixel electrode portion 212b. The second connecting portion 136b is between the second and third pixel electrode portions 212b and 212c to electrically connect the second pixel electrode portion 212b to the third pixel electrode portion 212c.

Each of the first to third pixel electrode portions 212a, 212b and 212c has a square shape including rounded corners. A portion of the third pixel electrode portion 212c is disposed in the contact hole. Therefore, the third pixel electrode portion 212c of the pixel electrode 220 is electrically coupled to the drain electrode 118c of the TFT 119. Alternatively, each of the first to third pixel electrode portions 212a, 212b and 212c has a polygonar shape, a circular shape, etc.

The storage capacitor 197 is formed on the lower plate 120 to maintain a voltage difference within the pixel electrode 220. The storage capacitor 197 includes a first storage electrode 193 and a second storage electrode 195. A portion of the storage capacitor 197 is protruded toward a central line of the pixel region 140. The protruded portion of the storage capacitor 197, for example, is substantially perpendicular to the central line of the pixel region 140.

Referring to FIGS. 15 and 16, the first storage electrode 193 is disposed on the lower plate 120, and electrically coupled to the storage capacitor line 191. A portion of the first storage electrode 193 is formed between the first and second pixel electrode portions 212a and 212b and/or between the second and third pixel electrode portions 212b and 212c to block a light that is irradiated into a space between the first and second pixel electrode portions 212a and 212b and/or between the second and third pixel electrode portions 212b and 212c. Therefore, the portion of the first storage electrode 193 is protruded into the pixel region 140. A remaining portion of the first storage electrode 193 is formed along an interface between the pixel region 140 and the light blocking region 145.

Referring to FIGS. 15 and 17, the second storage electrode 195 is disposed on a portion of the gate insulating layer 126 corresponding to the first storage electrode 193, and electrically coupled to the source electrode 118a. A portion of the second storage electrode 195 is formed between the first and second pixel electrode portions 212a and 212b and/or between the second and third pixel electrode portions 212b and 212c to block a light that is irradiated into a space between the first and second pixel electrode portions 212a and 212b and/or between the second and third pixel electrode portions 212b and 212c. Therefore, the portion of the second storage electrode 195 is protruded into the pixel region 140. A remaining portion of the second storage electrode 195, for example, is formed along the interface between the pixel region 140 and the light blocking region 145. Therefore, a remaining portion of the storage capacitor 197 is formed along the sides of the pixel region 140.

Alternatively, a second protecting layer (not shown) may be formed on the first to third pixel electrode portions 212a, 212b and 212c. The second protecting layer (not shown) is not rubbed and has a smooth surface and a uniform thickness. Alternatively, the second protecting layer (not shown) may be rubbed in a predetermined rubbing direction. The second protecting layer (not shown) has a synthetic resin such as a polyimide (PI) resin.

The black matrix 102 is formed in the peripheral region 155 of the upper plate 100. The color filter 104 is formed in the display region 150 of the upper plate 100. Therefore, a light having a predetermined wavelength may pass through the color filter 104.

The common electrode 106 is formed over the upper plate 100 having the black matrix 102 and the color filter 104. The common electrode 106 includes opening patterns 135a to form a multi-domain in the liquid crystal layer 108. The common electrode 106, for example, is partially etched to form the opening patterns 135a. The common electrode 106, for example, includes three opening patterns 135a. The opening patterns 135a are formed over the central portions of the first to third pixel electrode portions 212a, 212b and 212c of the pixel electrode 220, respectively.

The spacer 110 is formed on the upper plate 100 having the black matrix 102, the color filter 104, and the common electrode 106. The first substrate 170 is apart from the second substrate 180 by the spacer 110.

Alternatively, a first protecting layer (not shown) may be formed on the common electrode 106 and the opening patterns 135a. The first protecting layer (not shown) is not rubbed and has a smooth surface and a uniform thickness. The first protecting layer (not shown) has a synthetic resin such as a polyimide (PI) resin.

The liquid crystal layer 108 is interposed between the first and second substrates 170 and 180, and sealed by a sealant (not shown). The liquid crystal layer 108 may include a vertical alignment (VA) mode, a twisted nematic (TN) mode, a mixed twisted nematic (MTN) mode, a homogeneous alignment mode, a reverse electrically controlled birefringence (Reverse ECB) mode, etc. The liquid crystal layer 108, for example, includes the vertical alignment (VA) mode.

When voltages are applied to the pixel electrode 220 and the common electrode 106, a distorted electric field is formed in a region adjacent to the spacer 110, a region adjacent to each of the opening patterns 135a, and a region between the pixel electrode portions 212a, 212b and 212c. When the distorted electric field is applied to the liquid crystal layer 108, a multi-domain is formed in the liquid crystal layer 108. Therefore, a viewing angle of the LCD apparatus is improved.

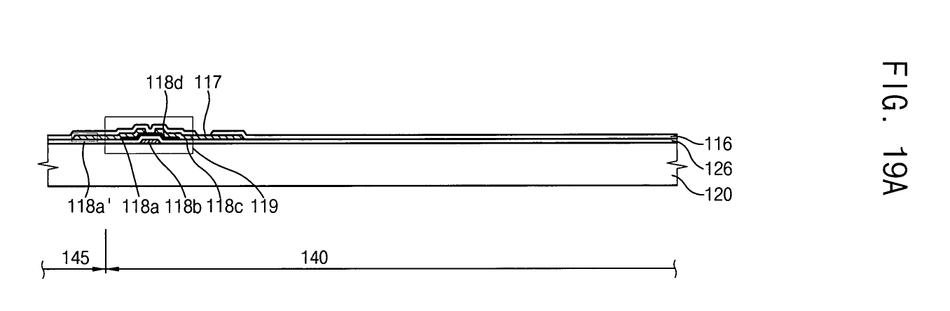

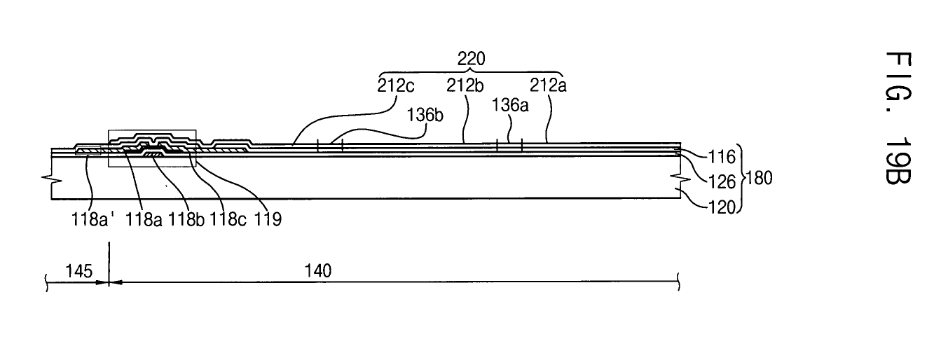

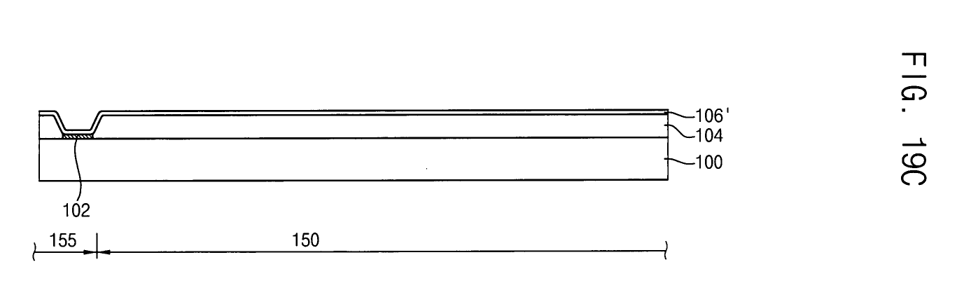

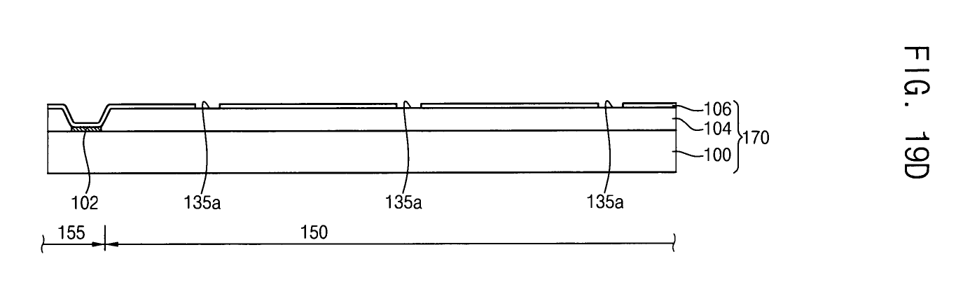

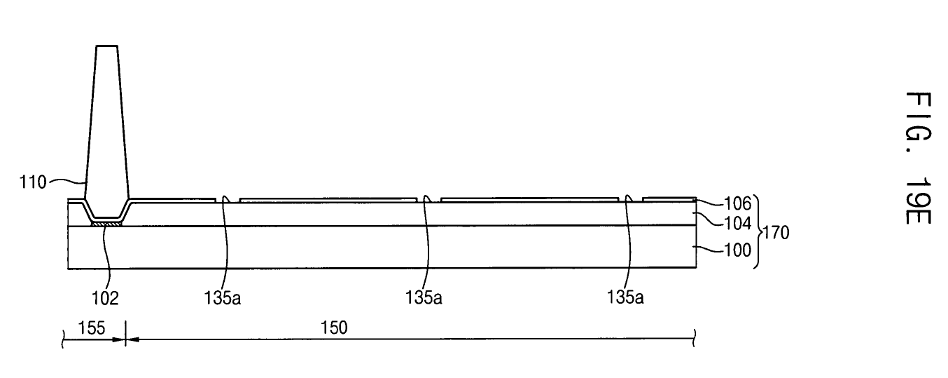

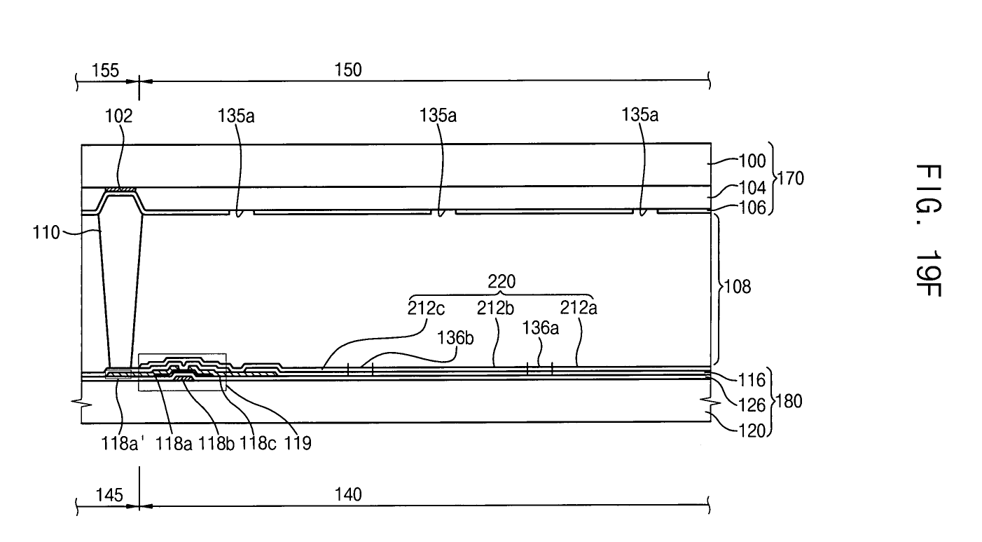

FIGS. 19A to 19F are cross-sectional views showing a method of manufacturing a LCD apparatus in accordance with another exemplary embodiment of the present invention. Referring to FIG. 19A, the lower plate 120 includes the pixel region 140 and the blocking region 145. A light generated from a backlight assembly (not shown) passes through the pixel region 140.

A conductive material is deposited on the lower plate 120. The deposited conductive material is partially removed to form the gate electrode 118b, the gate line 118b′, the first storage electrode 193 (shown in FIG. 15), and the storage capacitor line 191. The gate insulating layer 126 is deposited on the lower plate 120 having the gate electrode 118b and the gate line 118b′. The gate insulating layer 126 includes a transparent insulating material.

Amorphous silicon and N+ type amorphous silicon are formed on the gate insulating layer 126 and partially removed to form a semiconductor layer 118d on the gate insulating layer 126 corresponding to the gate electrode 118b. A conductive material is deposited on the gate insulating layer 126 having the semiconductor layer 118d. The conductive material deposited on the gate insulating layer 126 is partially etched to form the source electrode 118a, the source line 118a′, and the drain electrode 118c. Therefore, the TFT 119 that includes the source electrode 118a, the gate electrode 118b, the drain electrode 118c, and the semiconductor layer 118d, and the storage capacitor 197 that includes the first storage electrode 193 and the second storage electrode 195 are formed on the lower plate 120.

A transparent insulating material is deposited over the lower plate 120 having the TFT 119 and the storage capacitor 197. The deposited transparent insulating material is partially etched to form the passivation layer 116 having the contact hole 117 through which the drain electrode 118c is partially exposed.

Referring to FIG. 19B, a transparent conductive material is deposited on the passivation layer 116 and in the contact hole 117. The transparent conductive material includes indium tin oxide (ITO), indium zinc oxide (IZO), zinc oxide (ZO), etc. The transparent conductive material, for example, includes the ITO. The deposited transparent conductive material is partially etched to form the first to third pixel electrode portions 212a, 212b and 212c, and the first and second connecting portions 136a and 136b to form the pixel electrode 220.

Alternatively, a polyimide (PI) resin may be coated on the lower plate 120 having the pixel electrode 220 to form the second protecting layer (not shown). Therefore, the second substrate 180 having the lower plate 120, the TFT 119, the storage capacitor 197, the source line 118a′, the gate line 118b′, the storage capacitor line 191, and the pixel electrode 220 is completed.

Referring to FIG. 19C, an opaque material is deposited on the upper plate 100. The deposited opaque material is partially removed to form the black matrix 102.

A colored organic material having a colorant and photoresist is coated on the upper plate 100 having the black matrix 102. The coated colored organic material is exposed through a mask, and developed to form the color filter 104. A transparent conductive material 106′ is deposited on the upper plate 100 having the color filter 104 and the black matrix 102.

Referring to FIG. 19D, a photoresist film is coated on the deposited transparent conductive material 106′ (shown in FIG. 19C). The coated photoresist film is exposed through a mask, and developed to form a photoresist pattern. The deposited transparent conductive material 106′ is etched using the photoresist pattern as an etching mask to form the common electrode 106 having the opening patterns 135.

Referring to FIG. 19E, an organic material is coated on the common electrode 106. The organic material, for example, includes the photoresist. The coated organic material is exposed through a mask, and developed to form the spacer 110.

The polyimide (PI) resin may be coated on the upper plate 100 having the spacer 110 and the common electrode 106 to form the first protecting layer (not shown). Therefore, the first substrate 170 including the upper plate 100, the black matrix 102, the color filter 104, the common electrode 106, and the spacer 110 is completed.

Referring to FIG. 19F, the first substrate 170 is combined with the second substrate 180. The liquid crystal is injected into a space between the first and second substrates 170 and 180. The injected liquid crystal is sealed by the sealant (not shown) that is formed between the first and second substrates 170 and 180 to form the liquid crystal layer 108. Alternatively, the liquid crystal may be dropped on the first substrate 170 or the second substrate 180 having the sealant (not shown). Therefore, the first substrate 170 is combined with the second substrate 180 to form the liquid crystal layer 108.

Because each of the first to third pixel electrode portions 212a, 212b and 212c has the square shape having the rounded corners, and each of the opening patterns 135a has the circular shape, the domains are formed adjacent to the opening patterns 135a. Therefore, the viewing angle of the LCD apparatus increases.

In addition, the portions of the storage capacitor 197 are disposed between the first and second pixel electrode portions 212a and 212b and/or between the second and third pixel electrode portions 212b and 212c to block the light that is irradiated into the space between the first and second pixel electrode portions 212a and 212b and/or between the second and third pixel electrode portions 212b and 212c. Therefore, the portions of the first and second storage electrode 193 and 195 are protruded into the pixel region 140. Therefore, a light leakage is decreased, and an image display quality of the LCD apparatus is improved.

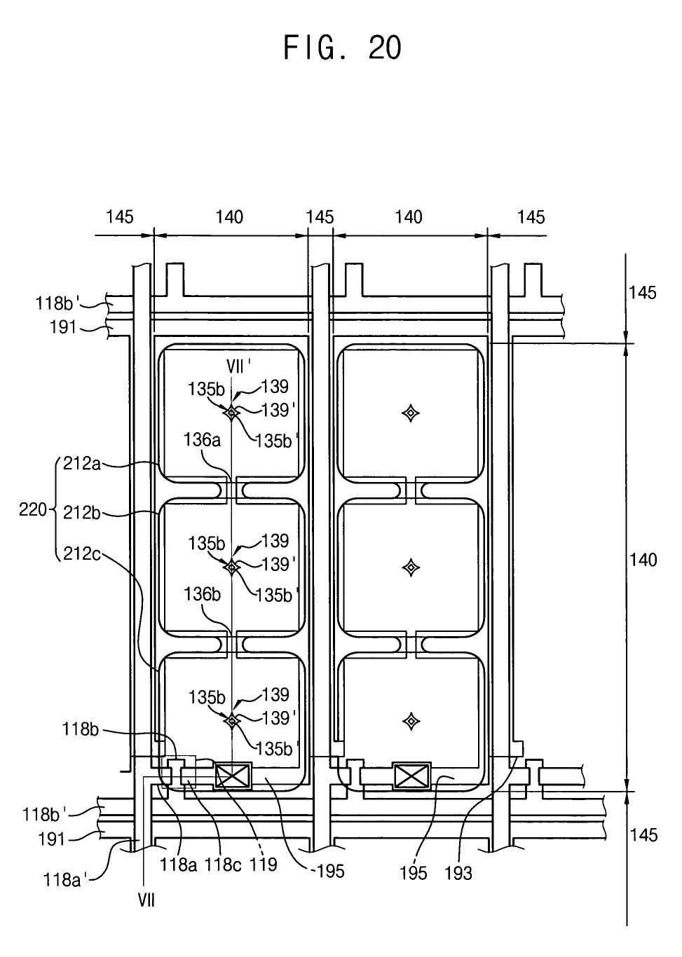

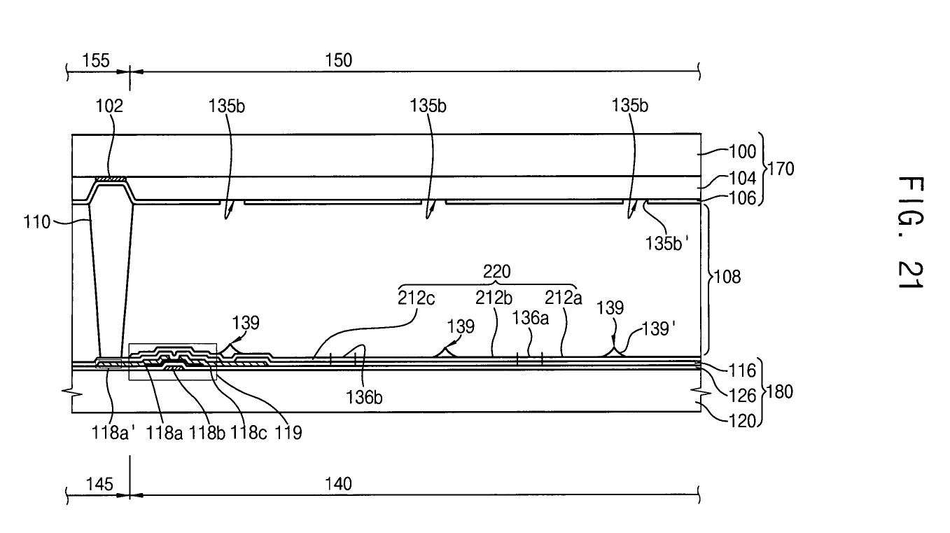

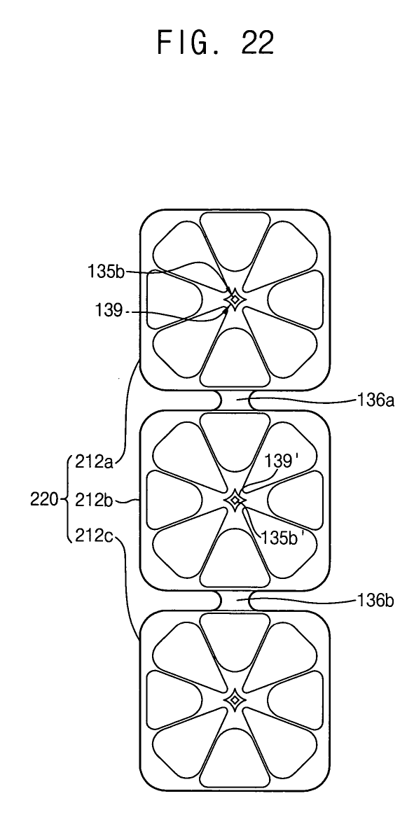

FIG. 20 is a plan view showing a LCD apparatus in accordance with another exemplary embodiment of the present invention. FIG. 21 is a cross-sectional view taken along a line VII-VII′ of FIG. 20. FIG. 22 is a plan view showing a multi-domain formed in a liquid crystal layer shown in FIG. 20. The LCD apparatus of FIGS. 20 and 21 is the same as in FIGS. 13 to 18 except for opening patterns and protrusions. Thus, the same reference numerals will be used to refer to the same or like parts as those described in FIGS. 13 to 18 and any further explanation will be omitted.

Referring to FIGS. 20 to 22, the LCD apparatus includes a first substrate 170, a second substrate 180 and a liquid crystal layer 108. The first substrate 170 includes an upper plate 100, a black matrix 102, a color filter 104, a common electrode 106, and a spacer 110. The first substrate 170 has a display region 150 and a peripheral region 155. An image is displayed in the display region 150 that is surrounded by the peripheral region 155.

The second substrate 180 includes a lower plate 120, a thin film transistor (TFT) 119, a source line 118a′, a gate line 118b′, a storage capacitor line 191, a gate insulating layer 126, a passivation layer 116, a storage capacitor 197, a protrusion 139, and a pixel electrode 220.

The second substrate 180 includes a pixel region 140 and a light blocking region 145. The image is displayed in the pixel region 140. A light may not pass through the light blocking region 145. The pixel region 140 and the light blocking region 145 correspond to the display region 150 and the peripheral region 155, respectively. The pixel region 140, for example, has a rectangular shape that is extended in a direction substantially parallel with the source line 118a′. The second substrate 180, for example, includes three protrusions 139 in unit pixel region 140. The pixel electrode 220 includes a first pixel electrode portion 212a, a second pixel electrode portion 212b, a third pixel electrode portion 212c, a first connecting portion 136a, and a second connecting portion 136b.

The protrusions 139 are formed on the first to third electrode portions 212a, 212b and 212c, respectively, to form a multi-domain in the liquid crystal layer 108. Each of the protrusions 139, for example, is formed on a central portion of each of the first to third electrode portions 212a, 212b and 212c.

Each of the protrusions 139 has a plurality of second recesses 139′. The longitudinal directions of the domains correspond to the horizontal directions of the second recesses 139′ of the protrusions 139, respectively. Each of the protrusions 139, for example, has four second recesses 139′. In order to form the protrusions 139, an organic material having photoresist is coated on the pixel electrode 220, and the coated organic material is partially removed through a photo process against the coated organic material.

The common electrode 106 is formed over the upper plate 100 having the black matrix 102 and the color filter 104. The common electrode 106 is formed over the upper plate 100 having the black matrix 102 and the color filter 104. The common electrode 106 includes opening patterns 135b to form the multi-domain in the liquid crystal layer 108. The common electrode 106, for example, is partially etched to form three opening patterns 135b in unit pixel region 140.

Each of the opening patterns 135b has a plurality of first recesses 135b′. The longitudinal directions of the domains correspond to the horizontal directions of the first recesses 135b′ of the opening pattern 135b, respectively. The first recesses 135b′ of the opening patterns 135b may have protruding portions. Each of the opening patterns 135b, for example, has four first recesses 135b′. The first recesses 135b′ of the opening pattern 135b correspond to the second recesses 139′ of the protrusion 139, respectively. Alternatively, each of the protrusions 139 may have at least five second recesses 139′, and each of the opening patterns 135b may also have at least five first recesses 135b′.

Referring to FIG. 22, the domains formed by the second recesses 139′ of the protrusions 139 and the first recesses 135b′ of the opening patterns 135b are formed in the portions of the liquid crystal layer 108 corresponding to the pixel electrode portions 212a, 212b and 212c. Therefore, the multi-domain is formed in the liquid crystal layer 108. Eight domains, for example, are formed in the portions of the liquid crystal layer 108 corresponding to the pixel electrode portions 212a, 212b and 212c. For example, the four domains of the eight domains correspond to the second recesses 139′ of the protrusions 139 and the first recesses 135b′ of the opening patterns 135b, and the remaining four domains of the eight domains correspond to the sides of the pixel electrode portions 212a, 212b and 212c.

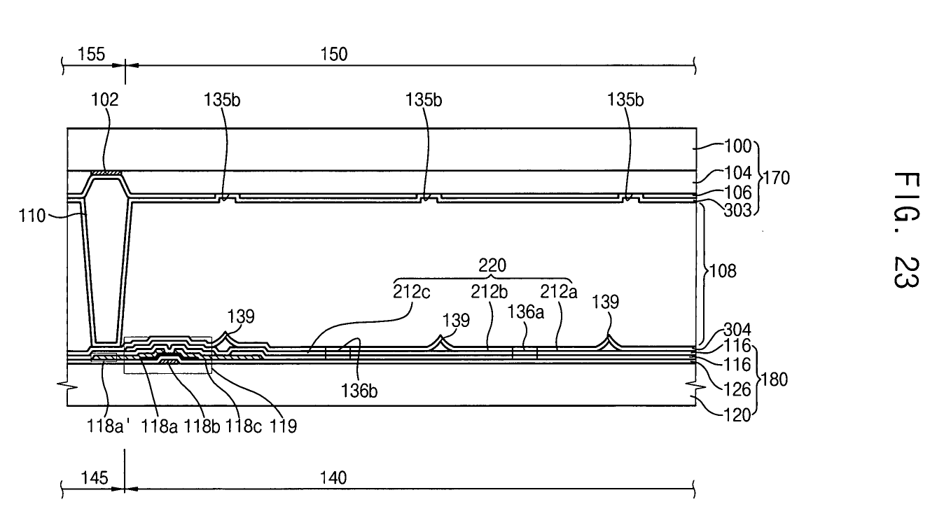

FIG. 23 is a cross-sectional view showing a LCD apparatus in accordance with another exemplary embodiment of the present invention. The LCD apparatus of FIG. 23 is the same as in FIGS. 20 to 22 except for a first protecting layer and a second protecting layer. Thus, the same reference numerals will be used to refer to the same or like parts as those described in FIGS. 20 to 22 and any further explanation will be omitted.

Referring to FIG. 23, the LCD apparatus includes a first substrate 170, a second substrate 180 and a liquid crystal layer 108. The first substrate 170 includes an upper plate 100, a black matrix 102, a color filter 104, a common electrode 106, a spacer 110, and a first protecting layer 303. The first substrate 170 has a display region 150 and a peripheral region 155. An image is displayed in the display region 150 that is surrounded by the peripheral region 155.

The second substrate 180 includes a lower plate 120, a thin film transistor (TFT) 119, a source line 118a′, a gate line 118b′, a storage capacitor line 191, a gate insulating layer 126, a passivation layer 116, a storage capacitor 197, a protrusion 139, a pixel electrode 220, and a second protecting layer 304.

The second substrate 180 includes a pixel region 140 and a light blocking region 145. The image is displayed in the pixel region 140. A light may not pass through the light blocking region 145. The pixel region 140 and the light blocking region 145 correspond to the display region 150 and the peripheral region 155, respectively. The second substrate 180, for example, includes three protrusions 139 in unit pixel region 140.

The second protecting layer 304 is formed on the pixel electrode 220 and the protrusions 139 to protect the pixel electrode 220 and the protrusions 139. The second protecting layer 304 is not rubbed and has a smooth surface and a uniform thickness. Alternatively, the second protecting layer 304 may be formed on the pixel electrode 220, and the protrusions 139 may be formed on the second protecting layer 304.

The first protecting layer 303 is formed on the common electrode 106 to protect the common electrode 106. The first protecting layer 303 is not rubbed and has a smooth surface and a uniform thickness. The liquid crystal layer 108 makes contact with the first and second protecting layers 303 and 304.

A multi-domain is formed in the liquid crystal display layer 108 by first and second recesses 135b′ and 139′ of the opening patterns 135b and the protrusions 139. In addition, the first and second protecting layers 301 and 302 are not rubbed to prevent a misalignment formed by rubbing.

According to one aspect of the present invention, a common electrode has opening patterns corresponding to transparent electrode portions and a reflecting electrode portion. Therefore, domains are formed adjacent to the opening patterns. In addition, each of the transparent electrode portions and the reflecting electrode portion includes a rectangular shape having rounded corners to increase the number of the domains.

According to another aspect of the present invention, each of the opening patterns has a circular shape. Therefore, the domains are radially formed adjacent to each of the opening patterns, and a viewing angle of the LCD apparatus is increased. In addition, first recesses are formed the opening patterns, and second recesses corresponding to the first recesses are formed on protrusions formed on a pixel electrode. The first and second recesses form a multiple domain.

According to another aspect of the present invention, the portions of a storage capacitor are disposed between the transparent electrode portions, and between the reflecting electrode and the transparent electrode portion adjacent to the reflecting electrode. Therefore, a light that is irradiated between the transparent electrode portions, and between the reflecting electrode and the transparent electrode portion adjacent to the reflecting electrode are blocked. Therefore, a leakage of the light is prevented, and an image display quality is improved.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

1. A liquid crystal display apparatus comprising:
a lower plate including a pixel region and a switching element disposed in the pixel region;
a pixel electrode formed in the pixel region of the lower plate and electrically coupled to an electrode of the switching element, the pixel electrode including a plurality of pixel electrode portions and at least one connecting portion that electrically connects the pixel electrode portions to each other;
an upper plate including a display region corresponding to the pixel region;
a common electrode disposed on the upper plate, the common electrode including a plurality of opening patterns that correspond to the pixel electrode portions, respectively; and
a liquid crystal layer interposed between the pixel electrode and the common electrode.

2. The liquid crystal display apparatus of claim 1, wherein the opening patterns of the common electrode correspond to central portions of the pixel electrode portions, respectively.

3. The liquid crystal display apparatus of claim 1, wherein each of the pixel electrode portions has a polygonal shape or a circular shape.

4. The liquid crystal display apparatus of claim 1, wherein each of the pixel electrode portions has a square shape.

5. The liquid crystal display apparatus of claim 1, wherein each of the pixel electrode portions has a square shape having rounded corners.

6. The liquid crystal display apparatus of claim 1, wherein the pixel electrode comprises:
a first pixel electrode portion having a transparent conductive material;
a second pixel electrode portion having the transparent conductive material;
a third pixel electrode portion having a conductive material of high reflectivity;
a first connecting portion electrically connecting the first pixel electrode portion to the second pixel electrode portion; and
a second connecting portion electrically connecting the second pixel electrode portion to the third pixel electrode portion.

7. The liquid crystal display apparatus of claim 1, further comprising an organic layer disposed on the lower plate having the pixel electrode portions, the pixel electrode portions having a transparent conductive material.

8. The liquid crystal display apparatus of claim 1, further comprising an organic layer disposed between the lower plate and the pixel electrode portions, the pixel electrode portions having a transparent conductive material,
and wherein the organic layer has a contact hole through which the electrode of the switching element makes electrical contact with the pixel electrode.

9. The liquid crystal display apparatus of claim 1, further comprising:
a first protecting layer disposed on the common electrode, the first protecting layer having a smooth surface and a uniform thickness; and
a second protecting layer disposed on the pixel electrode, the second protecting layer having a smooth surface and a uniform thickness,
and wherein the liquid crystal layer is interposed between the first and second protecting layers.

10. The liquid crystal display apparatus of claim 1, wherein each of the opening patterns of the common electrode comprises a plurality of first recesses to form a plurality of domains in the liquid crystal layer.

11. The liquid crystal display apparatus of claim 10, further comprising a storage capacitor electrically coupled to the pixel electrode,
and wherein a portion of the storage capacitor is formed between the pixel electrode portions adjacent to each other.

12. The liquid crystal display apparatus of claim 10, wherein each of the opening patterns comprises four first recesses.

13. The liquid crystal display apparatus of claim 10, further comprising a plurality of protrusions formed on the pixel electrode portions, respectively,
and wherein each of the protrusions corresponds to each of the opening patterns.

14. The liquid crystal display apparatus of claim 13, wherein each of the protrusions comprises a plurality of second recesses to form the domains in the liquid crystal layer.

15. The liquid crystal display apparatus of claim 10, wherein each of the pixel electrode portions comprises a quadrangular shape having rounded corners.

16. The liquid crystal display apparatus of claim 10, wherein each of the pixel electrode portions comprises a circular shape.

17. The liquid crystal display apparatus of claim 10, further comprising:
a first protecting layer disposed on the common electrode, the first protecting layer having a smooth surface and a uniform thickness;
a second protecting layer disposed on the pixel electrode, the second protecting layer having a smooth surface and a uniform thickness; and
a plurality of protrusions disposed between the pixel electrode portions and the second protecting layer corresponding to the opening patterns, respectively,
and wherein the liquid crystal layer is interposed between the first and second protecting layers.

18. The liquid crystal display apparatus of claim 17, wherein each of the protrusions comprises a plurality of second recesses to form the domains in the liquid crystal layer.

19. The liquid crystal display apparatus of claim 10, further comprising:
a first protecting layer disposed on the common electrode, the first protecting layer having a smooth surface and a uniform thickness;
a second protecting layer disposed on the pixel electrode, the second protecting layer having a smooth surface and a uniform thickness; and
a plurality of protrusions disposed on the second protecting layer corresponding to the opening patterns, respectively,
wherein the liquid crystal layer is interposed between the first and second protecting layers.

20. The liquid crystal display apparatus of claim 19, wherein each of the protrusions comprises a plurality of second recesses to form the domains in the liquid crystal layer.

21. A liquid crystal display apparatus comprising:
a lower plate including a pixel region and a switching element disposed in the pixel region, the pixel region including a transmission window and a reflection region;
a pixel electrode electrically coupled to an electrode of the switching element, the pixel electrode including:
a transparent electrode in the transmission window of the lower plate, the transparent electrode having a transparent conductive material;
a reflecting electrode in the reflection region of the lower plate, the reflecting electrode having a conductive material having high reflectivity; and
a connecting portion electrically connecting the transparent electrode to the reflecting electrode;
an upper plate including a display region corresponding to the pixel region;
a common electrode disposed on the upper plate, the common electrode including a plurality of opening patterns that corresponds to the transparent electrode and the reflecting electrode, respectively; and
a liquid crystal layer interposed between the pixel electrode and the common electrode.

22. The liquid crystal display apparatus of claim 21, wherein a portion of the liquid crystal layer corresponding to the reflection region has thinner thickness than thickness of a portion of the liquid crystal layer corresponding to the transmission window.

23. The liquid crystal display apparatus of claim 21, wherein the transparent electrode comprises a plurality of transparent electrode portions and at least one connecting portion electrically connecting the transparent electrode portions to each other.

24. The liquid crystal display apparatus of claim 23, wherein each of the transparent electrode portions has a square shape having rounded corners.

25. A liquid crystal display apparatus comprising:
a lower plate including a pixel region and a switching element disposed in the pixel region;
a pixel electrode formed in the pixel region of the lower plate and electrically coupled to an electrode of the switching element;
a storage capacitor disposed on the lower plate, a portion of the storage capacitor protruded toward a central line of the pixel region;
an upper plate including a display region corresponding to the pixel region;
a common electrode disposed on the upper plate, the common electrode corresponding to the pixel electrode; and
a liquid crystal layer interposed between the pixel electrode and the common electrode.

26. The liquid crystal display apparatus of claim 25, wherein the pixel electrode comprises a plurality of pixel electrode portions and at least one connecting portion electrically connecting the pixel electrode portions to each other.

27. The liquid crystal display apparatus of claim 25, wherein the common electrode comprises a plurality of opening patterns, and each of the opening patterns includes a plurality of first recesses.

28. The liquid crystal display apparatus of claim 25, wherein a remaining portion of the storage capacitor is formed along sides of the pixel region.

29. A method of manufacturing a liquid crystal display apparatus comprising:
forming a switching element in a pixel region of a lower plate;
forming a pixel electrode including a plurality of pixel electrode portions and at least one connecting portion electrically connecting the pixel electrode portions to each other in the pixel region of the lower plate, the pixel electrode being electrically coupled to an electrode of the switching element;
depositing a first transparent conductive material on an upper plate including a display region corresponding to the pixel region;
removing a portion of the first transparent conductive material corresponding to central portions of the pixel electrode portions to form a plurality of opening patterns; and
forming a liquid crystal layer between the pixel electrode and the first transparent conductive material including the opening patterns.

30. The method of claim 29, wherein removing a portion of the first transparent conductive material corresponding to central portions of the pixel electrode portions to form a plurality of opening patterns comprises:
coating a photoresist film on the first transparent conductive material;
exposing the coated photoresist film using a mask;
developing the exposed photoresist film to form a photoresist pattern; and
etching the first transparent conductive material using the photoresist pattern as an etching mask.

31. The method of claim 29, further comprising an insulating layer on the lower plate including the switching element, and wherein the insulating layer has a contact hole through which the electrode of the switching element is partially exposed.

32. The method of claim 31, wherein forming a pixel electrode comprises:
depositing a second transparent conductive material on the insulating layer and in the contact hole;
partially etching the second transparent conductive material to form a first pixel electrode portion, a second pixel electrode portion adjacent to the first pixel electrode portion, a first connecting portion electrically connecting the first pixel electrode portion to the second pixel electrode portion, and a second connecting portion electrically connecting the second pixel electrode portion to the electrode of the switching element through the contact hole;
depositing a conductive material having high reflectivity on the insulating layer having the first and second pixel electrode portions and the first and second connecting portions; and
partially etching the deposited conductive material having the high reflectivity to form a third pixel electrode portion that is electrically coupled to the second connecting portion.

33. The method of claim 29, wherein forming a pixel electrode comprises:
forming a first pixel electrode portion of the pixel electrode in the pixel region, the first pixel electrode portion having a second transparent conductive material; and
forming an organic layer on the lower plate having the first pixel electrode portion.

34. The method of claim 29, wherein forming a pixel electrode comprises:
forming an organic layer on the lower plate, the organic layer having a contact hole through which the electrode of the switching element is partially exposed; and
forming a first pixel electrode portion of a pixel electrode on a portion of the organic layer corresponding to the pixel region, the first pixel electrode portion having a second transparent conductive material.

35. The method of claim 29, further comprising:
coating a polyimide (PI) resin on the upper plate having the deposited conductive material to form a first protecting layer; and
coating the polyimide (PI) resin on the lower plate having the pixel electrode to form a second protecting layer.

36. A method of manufacturing a liquid crystal display apparatus comprising:
forming a switching element on a lower plate including a pixel region, the pixel region including a transmission window and a reflection region;
forming an insulating layer on the lower plate including the switching element, the insulating layer including a contact hole through which an electrode of the switching element is partially exposed;
depositing a first transparent conductive material on the insulating layer;
partially etching the first transparent conductive material to form a transparent electrode including a plurality of transparent electrode portions, a first connecting portion electrically connecting the transparent electrode portions to each other, and a second connecting portion electrically connecting one of the transparent electrode portions to the electrode of the switching element;
depositing a conductive material having high reflectivity on the lower plate including the transparent electrode;
partially etching the deposited conductive material to form a reflecting electrode that is electrically coupled to the transparent electrode;
depositing a second transparent conductive material on an upper plate including a display region corresponding to the pixel region;
removing a portion of the second transparent conductive material corresponding to central portions of the transparent electrode portions to form opening patterns; and
forming a liquid crystal layer between the transparent electrode and the second transparent conductive material and between the reflecting electrode and the second transparent conductive material.

37. A method of manufacturing a liquid crystal display apparatus comprising:
forming a semiconductor circuit on a lower plate including a pixel region;
forming a pixel electrode electrically coupled to a first electrode of a switching element of the semiconductor circuit in the pixel region of the lower plate, the pixel electrode including a plurality of pixel electrode portions and at least one connecting portion electrically connecting the pixel electrode portions to each other;
depositing a transparent conductive material on an upper plate including a display region corresponding to the pixel region;
removing a portion of the deposited transparent conductive material corresponding to central portions of the pixel electrode portions to form a plurality of opening patterns, each of the opening patterns including a plurality of first recesses; and
forming a liquid crystal layer between the pixel electrode and the deposited transparent conductive material.

38. The method of claim 37, wherein forming a semiconductor circuit comprises:
forming a gate electrode of the switching element and a first storage electrode spaced apart from the gate electrode on the lower plate, a portion of the first storage electrode protruded toward a central line of the pixel region;
forming a gate insulating layer on the lower plate having the gate electrode and the first storage electrode;
forming a semiconductor layer on a portion of the gate insulating layer corresponding to the gate electrode;
forming a conductive layer on the gate insulating layer having the semiconductor layer; and
partially removing the conductive layer to form the first electrode on the semiconductor layer, a second electrode spaced apart from the first electrode, and a second storage electrode formed on a portion of the gate insulating layer corresponding to the first storage electrode.

39. The method of claim 37, further comprising:
coating a polyimide (PI) resin on the upper plate having the deposited transparent conductive material to form a first protecting layer; and
coating a polyimide (PI) resin on the lower plate having the pixel electrode to form a second protecting layer.
